(19) United States
(12) Patent Application Publication
(10) Pub. No.: US 2025/0109264 A1
(43) Pub. Date: Apr. 3, 2025

(54) FILM, METHOD FOR MANUFACTURING SAME, AND IMAGE DISPLAY DEVICE

(71) Applicant: KANEKA CORPORATION, Osaka (JP)

(72) Inventors: Kohei Ogawa, Osaka (JP); Keisuke Katayama, Osaka (JP)

(73) Assignee: KANEKA CORPORATION, Osaka (JP)

(21) Appl. No.: 18/909,111

(22) Filed: Oct. 8, 2024

Related U.S. Application Data
(63) Continuation of application No. PCT/JP2023/014281, filed on Apr. 6, 2023.

(30) Foreign Application Priority Data
Apr. 8, 2022 (JP) 2022-064795

(51) Int. Cl. C08J 5/18; C08L 33/12; C08L 33/14; C08L 79/08; H05K 5/03

(52) U.S. Cl. CPC C08J 5/18; C08L 33/12; C08L 33/14; C08L 79/08; H05K 5/03; C08J 2333/12; C08J 2379/08; C08J 2479/08; C08L 2203/16

(57) ABSTRACT

A film including a polyimide and an acrylic resin is disclosed. An in-plane average refractive index n_{H} and a thickness direction refractive index n₃ of the film satisfy n_{H}−n₃≥0.0140, where the in-plane average refractive index n_{H} is an average value of a refractive index n₁ in a first direction in which refractive index in a film plane is maximum and a refractive index n₂ in a second direction orthogonal to the first direction in the film plane. A total light transmittance of the film may be 85% or more, a haze of the film may be 10% or less, and a yellowness index of the film may be 5 or less. The film can be produced by, for example, stretching an unstretched film including a polyimide and an acrylic resin in at least one direction. The film may be a biaxially stretched film.

### TECHNICAL FIELD

One or more embodiments of the present invention relate to a film and production method therefor, and an image display device including the film.

### BACKGROUND

Electronics devices such as display devices such as liquid crystal displays, organic EL displays and electronic papers, solar cells, and touch panels are required to be thin, lightweight, and flexible. Glass materials that are used for these devices are replaced by film materials to make the devices flexible, thin, and lightweight. As a replacement for glass, a transparent polyimide film has been developed and used for substrates for displays, cover films (cover windows) arranged on the outermost surface of display devices, and the like (see e.g., Patent Document 1). It is also proposed to use a polyimide having an amide structure (so called “polyamideimide”) as a material for cover films (see e.g., Patent Document 2).

In order to apply such a film to bendable applications such as flexible displays, studies have been made to improve the bending resistance of a transparent polyimide film. For example, Patent Document 1 describes that bending resistance is improved by stretching a polyimide film.

### PATENT DOCUMENT

Patent Document 1: JP 2019-6933 A
Patent Document 2: wo 2013/048126 A

Although polyimide is excellent in heat resistance, in order to stretch a polyimide film, it is necessary to heat the film to a high temperature of 250° C. or higher due to a high glass transition temperature of polyimide. Polyimide tends to be colored yellow when heated to a high temperature, and the transparency thereof tends to decrease, and it is not easy to achieve both transparency and high mechanical strength.

### SUMMARY

In view of the above, one or more embodiments of the present invention are to provide a transparent film having excellent transparency and excellent mechanical strength applicable to a flexible display.

One or more embodiments of the present invention relate to a film containing a polyimide and an acryl-based resin and having refractive index anisotropy, in which a difference n_{H}−n₃ between an in-plane average refractive index n_{H} and a thickness direction refractive index n₃ is 0.0140 or more.

The in-plane average refractive index n_{H} is an average value of a refractive index n₁ in a first direction in which the refractive index in the film plane is maximum and a refractive index n₂ in a second direction orthogonal to the first direction in the film plane. The refractive index n₁ in the first direction and the refractive index n₂ in the second direction may satisfy 100×(n₁−n₂)/n₂<1.0.

The total light transmittance of the film may be 85% or more, the haze may be 10% or less, and the yellowness index may be 5 or less. The glass transition temperature of the film may be 110° C. or higher and lower than 250° C. The ratio of the polyimide resin to the acryl-based resin contained in the film may be 98:2 to 2:98 in terms of the weight ratio.

The polyimide contained in the film has a diamine-derived structure and a tetracarboxylic-dianhydride-derived structure. In one or more embodiments, in the polyimide, at least one of a diamine-derived structure (diamine component) and a tetracarboxylic-dianhydride-derived structure (acid dianhydride component) may have a fluoroalkyl group. The polyimide may be a polyamideimide containing a dicarboxylic-acid-derived structure in addition to the diamine-derived structure and the tetracarboxylic-dianhydride-derived structure.

The polyimide may contain a diamine having a fluoroalkyl group as a diamine component. Examples of the diamine having a fluoroalkyl group include fluoroalkyl-substituted benzidines such as 2,2′-bis(trifluoromethyl)benzidine (TFMB).

The polyimide may contain as an acid dianhydride component, at least one selected from the group consisting of a tetracarboxylic dianhydride having a fluoroalkyl group and an alicyclic tetracarboxylic dianhydride.

In one or more embodiments, in the acryl-based resin contained in the film, the total amount of methyl methacrylate and modified structures of methyl methacrylate based on the total amount of the monomer components is 60 wt % or more. The glass transition temperature of the acryl-based resin may be 80° C. or higher.

The film may have a tensile modulus of 3.5 GPa or more in both of the first direction and the second direction.

The film is obtained, for example, by stretching a film (unstretched film) containing polyimide and an acryl-based resin in at least one direction. That is, the film of one or more embodiments of the present invention may be a stretched film stretched in at least one direction. The film may be a biaxially stretched film. The temperature during stretching may be lower than 250° C.

In one or more embodiments, an unstretched film is obtained by applying a resin solution in which a polyimide and an acryl-based resin are dissolved in an organic solvent onto a support, and removing the organic solvent. By stretching this film in at least one direction, a stretched film having refractive index anisotropy is obtained.

The above-described film is excellent in transparency and has high mechanical strength such as bending resistance, and thus can be suitably used for cover films and the like of flexible displays.

### DETAILED DESCRIPTION

The film according to one or more embodiments of the present invention contains a polyimide resin and an acryl-based resin, and exhibits transparency because the polyimide resin and the acryl-based resin are compatible with each other. The film of one or more embodiments of the present invention has refractive index anisotropy, and a difference n_{H}−n₃ between an in-plane average refractive index n_{H} and a thickness direction refractive index n₃ is 0.0140 or more. That is, the in-plane average refractive index n_{H} and the thickness direction refractive index n₃ satisfy n_{H}−n₃≥0.0140.

The in-plane average refractive index n_{H} is an average value of a refractive index n₁ in a first direction in which the refractive index in the film plane is maximum and a refractive index n₂ in a second direction orthogonal to the first direction in the film plane. The refractive index n₁ in the first direction and the refractive index n₂ in the second direction may satisfy 100×(n₁−n₂)/n₂<1.0.

A method for producing a film having refractive index anisotropy is not particularly limited. For example, a film is produced from a resin composition (resin mixture) containing a polyimide resin and an acryl-based resin exhibiting compatibility, and the film is stretched in at least one direction, thereby imparting refractive index anisotropy to the film. The film that satisfies 100×(n₁−n₂)/n₂<1.0 may be obtained by, for example, biaxially stretching a film.

### [Polyimide]

As the polyimide exhibiting compatibility with the acryl-based resin, a polyimide soluble in an organic solvent is preferable. The polyimide soluble in an organic solvent may be dissolved in N,N-dimethylformamide (DMF) at a concentration of 1 wt % or more. The polyimide may be soluble in a non-amide-based solvent as well as in an amide-based solvent such as DMF.

Polyimide is a polymer having a structural unit represented by general formula (I), and is obtained by cyclodehydration of a polyamic acid obtained by addition polymerization of a tetracarboxylic dianhydride (hereinafter, sometimes referred to as an “acid dianhydride”) with a diamine. That is, the polyimide is a polycondensation product of tetracarboxylic dianhydride and a diamine, and has an acid dianhydride-derived structure (acid dianhydride component) and a diamine-derived structure (diamine component). Polyimide may also be synthesized by decarboxylation condensation of a diisocyanate and a dianhydride.

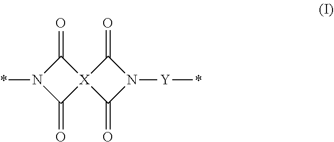

In general formula (I), Y is a divalent organic group, and X is a tetravalent organic group. Y is a diamine residue, and is an organic group obtained by removing two amino groups from a diamine represented by the following general formula (II). X is a tetracarboxylic dianhydride residue, and is an organic group obtained by removing two carboxy anhydride groups from a tetracarboxylic dianhydride represented by the following general formula (III).

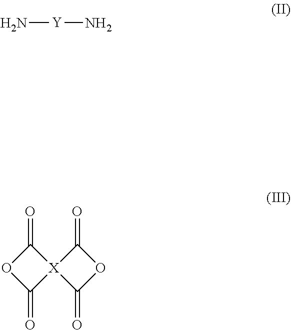

In other words, the polyimide contains a structural unit represented by the following general formula (IIa) and a structural unit represented by the following general formula (IIIa). The diamine-derived structure (IIa) and the tetracarboxylic dianhydride-derived structure (IIIa) form an imide bond, whereby the polyimide has a structural unit represented by the general formula (I).

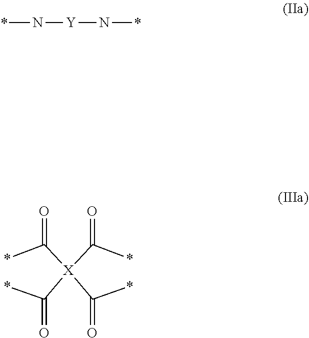

The polyimide may contain a structural unit represented by the following general formula (IV) (amide structural unit) in addition to the imide structural unit represented by general formula (I). A polyimide containing an amide structural unit in addition to the imide structural unit is also referred to as polyamideimide.

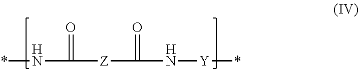

In the general formula (IV), Y and Z are divalent organic groups. Y is a diamine residue as in the general formula (I). Z is a dicarboxylic acid residue, and is an organic group obtained by removing two carboxy groups from a dicarboxylic acid represented by the following general formula (V). In synthesis of the polyamideimide, a dicarboxylic acid dichloride represented by general formula (V′) may be used instead of the dicarboxylic acid. A dicarboxylic anhydride may be used instead of the dicarboxylic acid.

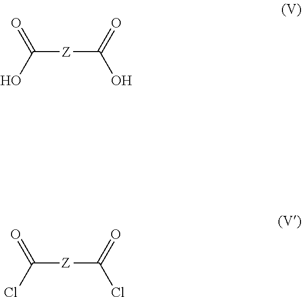

The diamine-derived structure represented by the above general formula (IIa) and the dicarboxylic-acid-derived structure represented by the following general formula (Va) form an amide bond to thereby form an amide structural unit represented by the general formula (V). That is, the polyamideimide includes a diamine-derived structure (IIa), a tetracarboxylic-dianhydride-derived structure (IIIa), and a dicarboxylic-acid-derived structure (Va).

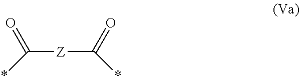

The polyamideimide has a structure represented by the following general formula (VI) in which a diamine-derived structure (IIa) is bonded to both ends of a dicarboxylic-acid-derived structure (Va).

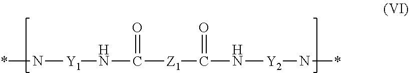

In the general formula (VI), Y₁ and Y₂ are diamine residues, and Z₁ is a dicarboxylic acid residue. When the moiety of [—Y₁—NH—CO—Z₁—CO—NH—Y₂-] in the general formula (VI) is regarded as one divalent organic group, this divalent organic group can be treated as one diamine residue Y containing two amide bonds. That is, in the general formula (I), it can be said that the polyimide in which the diamine residue Y contains an amide bond is polyamideimide, and thus the polyamideimide may be treated as one type of polyimide. Hereinafter, unless otherwise specified, the term “polyimide” includes “polyamideimide”.

As described above, in addition to a method of synthesizing a polyimide from a tetracarboxylic dianhydride and a diamine via a polyamic acid, the polyimide can also be synthesized by condensation or the like through decarboxylation of a tetracarboxylic dianhydride and a diisocyanate. In any of the synthesis methods, the obtained polyimide has an acid dianhydride-derived structure (tetracarboxylic dianhydride residue) X obtained by removing four carboxy groups from a tetracarboxylic dianhydride and a diamine-derived structure (diamine residue) Y obtained by removing two amino groups from a diamine. Therefore, even when the starting material used for synthesis of the polyimide is not a tetracarboxylic dianhydride or a diamine, a structure corresponding to the tetracarboxylic dianhydride residue contained in the polyimide is expressed as an “acid dianhydride component,” and a structure corresponding to the diamine residue is expressed as a “diamine component.” In synthesis of the polyamideimide, a dicarboxylic acid derivative such as a dicarboxylic acid dichloride or a dicarboxylic anhydride is used, but the resulting polyamideimide has a structure Z (dicarboxylic acid residue) obtained by removing two carboxy groups from a dicarboxylic acid. Therefore, even when a starting material used for the synthesis of the polyimide is a dicarboxylic acid derivative, a structure corresponding to a dicarboxylic acid residue is expressed as a “dicarboxylic acid component”.

The polyimide may include a plurality of types of diamine residues Y, a plurality of types of tetracarboxylic dianhydride residues X, and a plurality of types of dicarboxylic acid residues Z. Hereinafter, a diamine component and an acid dianhydride component as monomer units constituting the polyimide, and a dicarboxylic acid component in a case where the polyimide is polyamideimide will be described by way of examples.

### <Diamine>

Although the diamine component is not particularly limited, the diamine component of the polyimide may contain a diamine having a fluoroalkyl group from the viewpoint of enhancing compatibility with the acryl-based resin. Among diamines having a fluoroalkyl group, a fluoroalkyl-substituted benzidine is particularly preferable. When the polyimide contains a fluoroalkyl-substituted benzidine as the diamine component, the polyimide has improved solubility and transparency and tends to have improved compatibility with the acryl-based resin.

(Fluoroalkyl-Substituted Benzidine)

Examples of the fluoroalkyl-substituted benzidine include 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,3′,5,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoro)methyl) benzidine, 2,2′-bis(trifluoromethyl)benzidine, 3,3′-bis(trifluoromethyl)benzidine, 2,3′-bis(trifluoromethyl)benzidine, 2,2′,3-tris(trifluoromethyl) benzidine, 2,3,3′-tris(trifluoromethyl) benzidine, 2,2′,5-tris(trifluoromethyl) benzidine, 2,2′,6-tris(trifluoromethyl)) benzidine, 2,3′,5-tris(trifluoromethyl) benzidine, 2,3′,6,-tris(trifluoromethyl) benzidine, 2,2′,3,3′-tetrakis(trifluoromethyl) benzidine, 2,2′,5,5′-tetrakis(trifluoromethyl) benzidine, and 2,2′,6,6′-tetrakis(trifluoromethyl) benzidine.

Among the fluoroalkyl-substituted benzidines, the fluoroalkyl group of the fluoroalkyl-substituted benzidine may be a perfluoroalkyl group from the viewpoint of achieving both solubility and transparency of the polyimide. The perfluoroalkyl group may be a trifluoromethyl group. In particular, from the viewpoint of the solubility of the polyimide in an organic solvent and the compatibility of the polyimide with the acryl-based resin, perfluoroalkyl-substituted benzidines having a perfluoroalkyl group at the 2-position of biphenyl are preferable, and 2,2′-bis(trifluoromethyl) benzidine (hereinafter, referred to as “TFMB”) is particularly preferable. When a trifluoromethyl group is present at each of 2- and 2′-positions of biphenyl, the π-electron density decreases due to the electron-attracting property of the trifluoromethyl group, and a bond between two benzene rings of biphenyl is twisted by steric hindrance of the trifluoromethyl group, leading to a decrease in planarity of the π-conjugate. Therefore, the absorption edge wavelength shifts to a short wave, so that coloring of the polyimide can be suppressed.

The ratio of the fluoroalkyl-substituted benzidine to total amount of the diamine components may be 50 mol % or more, 60 mol % or more, 70 mol % or more, 80 mol % or more, 85 mol % or more, or 90 mol % or more. A large content of the fluoroalkyl-substituted benzidine tends to lead to enhancement of compatibility between the polyimide resin and the acryl-based resin, and suppression of coloring of the film, and tends to lead enhancement of mechanical strength in terms of pencil hardness, tensile modulus, and the like.

### (Diamine Having Amide Bond)

As the diamine component of the polyimide, a diamine having an amide bond may also be used. For example, an amide produced by bonding a diamine to carboxy groups at both ends of a dicarboxylic acid is represented by general formula (VII).

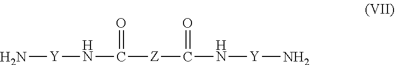

In the general formula (VII), Y is a diamine residues, and Z is a dicarboxylic acid residue. The amide structure-containing diamine represented by general formula (VII) is composed of one dicarboxylic acid (derivative) and two diamines, and therefore in calculation of the composition of the polyimide (polyamideimide), the amide structure-containing diamine is regarded as having one dicarboxylic acid residue and two diamine residues. The general formula (VII) shows a structure in which one dicarboxylic acid and two diamines are condensed, but two dicarboxylic acids and three diamines may be condensed, or three or more dicarboxylic acids and four or more diamines may be condensed.

A polyimide containing a diamine having an amide structure represented by the general formula (VII) as the diamine component contains an amide bond in addition to an imide bond, and thus correspond to polyamideimide. In synthesis of the polyamideimide, a polyimide containing the structure represented by the general formula (IV) (i.e., a polyamideimide) may be synthesized using, as a monomer, an amine-terminated amide oligomer instead of the dicarboxylic acid derivative. The dicarboxylic acid derivative and the amine-terminated amide oligomer may be used in combination.

The dicarboxylic acid in the diamine having an amide structure represented by the general formula (VII) is not particularly limited, and various aliphatic dicarboxylic acids, aromatic dicarboxylic acids, alicyclic dicarboxylic acids, and heterocyclic dicarboxylic acids used for the synthesis of the polyamideimide can be applied. Details of the dicarboxylic acid component will be described later. In preparation of the compound containing a condensed structure of a diamine and a dicarboxylic acid, a dicarboxylic acid derivative such as dicarboxylic acid dichloride or dicarboxylic anhydride may be used instead of the dicarboxylic acid.

Specific examples of the diamine containing a condensed structure of a fluoroalkyl-substituted benzidine and a dicarboxylic acid include a condensate of TFMB and a dicarboxylic acid. The dicarboxylic acid may be terephthalic acid and/or isophthalic acid. For example, a diamine in which TFMB is condensed at both ends of terephthalic acid has a structure of the following formula (4).

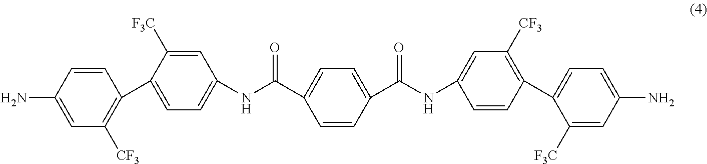 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

### (Fluoroalkyl Group-Containing Diamine)

Examples of the diamine having a fluoroalkyl group (other than the fluoroalkyl-substituted benzidine) include diamines having an aromatic ring to which a fluoroalkyl group is bonded, such as 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino-2,3,5,6-tetrakis(trifluoromethyl) benzene; and diamines having a fluoroalkyl group not directly bonded to an aromatic ring, such as 2,2-bis(4-aminophenyl) hexafluoropropane, 2,2-bis(3-aminophenyl) hexafluoropropane, and 2,2-bis[4-(4-aminophenoxy)phenyl]hexafluoropropane.

The polyimide may contain a fluoroalkyl group-free diamine as the diamine component. Among fluoroalkyl group-free diamines, examples of the diamine component exhibiting compatibility with the acryl-based resin in the polyimide include alicyclic diamines, diamines having a fluorene skeleton, diamines having a sulfone group, and fluorine-containing diamines.

Examples of the fluorine-containing diamine (one containing no fluoroalkyl group) include 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′3-trifluorobenzidine, 2,3,3′-trifluorobenzidine, 2,2′5-trifluorobenzidine, 2,2′6-trifluorobenzidine, 2,3′5-trifluorobenzidine, 2,3′6-trifluorobenzidine, 2,2′3,3′-tetrafluorobenzidine, 2,2′5,5′-tetrafluorobenzidine, 2,2′6,6′-tetrafluorobenzidine, 2,2′3,3′6,6′-hexafluorobenzidine, 2,2′3,3′5,5′6,6′-octafluorobenzidine, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, and 2,2′-dimethylbenzidine.

### (Alicyclic Diamine)

Examples of the diamine having an alicyclic structure include isophoronediamine, 1,2-cyclohexanediamine, 1,3-cyclohexanediamine, 1,4-cyclohexanediamine, 1,2-bis(aminomethyl) cyclohexane, 1,3-bis(aminomethyl) cyclohexane, 1,4-bis(aminomethyl) cyclohexane, bis(aminomethyl) norbornene, 4,4′-methylenebis(cyclohexylamine), bis(4-aminocyclohexyl) methane, 4,4′-methylenebis(2-methylcyclohexylamine), adamantane-1,3-diamine, 2,6-bis(aminomethyl) bicyclo[2.2.1]heptane, 2,5-bis(aminomethyl) bicyclo[2.2.1]heptane, and 1,1-bis(4-aminophenyl)cyclohexane.

The polyimide may contain a diamine other than the fluo

### (Diamine Having Fluorene Skeleton)

Examples of the diamine having a fluorene skeleton include 9,9-bis(4-aminophenyl) fluorene.

### (Sulfone Group-Containing Diamine)

Examples of the diamine having a sulfone group include 3,3′-diaminodiphenylsulfone, 3,4′-diaminodiphenylsulfone, 4,4′-diaminodiphenylsulfone, bis[4-(3-aminophenoxy)phenyl]sulfone, and bis[4-(4-aminophenoxy)phenyl]sulfone, 4,4′-bis[4-(4-amino-α,α-dimethylbenzyl)phenoxy]diphenylsulfone, and 4,4′-bis[4-(4-(aminophenoxy)phenoxy)diphenylsulfone. Among them, diaminodiphenylsulfones such as 3,3′-diaminodiphenylsulfone (3,3′-DDS) and 4,4′-diaminodiphenylsulfone (4,4′-DDS) are preferable.

### (Other Diamines)

Examples of diamines other than those described above include aromatic diamines such as p-phenylenediamine, m-phenylenediamine, o-phenylenediamine, p-xylenediamine, m-xylenediamine, o-xylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]ether, bis[4-(4-aminophenoxy)phenyl]ether, 2,2-bis[4-(3-aminophenoxy)phenyl]ether, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′3′-tetramethyl-1,1′-spirobiindane, and 6,6′-bis(4-aminophenoxy)-3,3,3′3′-tetramethyl-1,1′-spirobiindane.

As the diamine, chain diamines can also be used such as bis(aminomethyl) ether, bis(2-aminoethyl) ether, bis(3-aminopropyl) ether, bis(2-aminomethoxy)ethylJether, bis[2-(2-aminoethoxy)ethyl]ether, bis[2-(3-aminoprotoxy)ethyl]ether, 1,2-bis(aminomethoxy) ethane, 1,2-bis(2-aminoethoxy) ethane, 1,2-bis[2-(aminomethoxy) ethoxy]ethane, 1,2-bis[2-(2-aminoethoxy) ethoxy]ethane, ethylene glycol bis(3-aminopropyl) ether, diethylene glycol bis(3-aminopropyl) ether, triethylene glycol bis(3-aminopropyl) ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,3-bis(3-aminopropyl)tetramethyldisiloxane, 1,3-bis(4-aminobutyl)tetramethyldisiloxane, α,ω-bis(3-aminopropyl) polydimethylsiloxane, and α,ω-bis(3-aminobutyl) polydimethylsiloxane.

### <Tetracarboxylic Dianhydrides>

Although the acid dianhydride component is not particularly limited, the acid dianhydride component of the polyimide may contain at least one of a tetracarboxylic dianhydride having a fluoroalkyl group and an alicyclic tetracarboxylic dianhydride from the viewpoint of enhancing compatibility with the acryl-based resin. When the polyimide contains a tetracarboxylic dianhydride having a fluoroalkyl group or an alicyclic tetracarboxylic dianhydride as an acid anhydride component, the polyimide has improved solubility and transparency, and tends to have improved compatibility with the acryl-based resin.

### (Fluoroalkyl Group-Containing Tetracarboxylic Dianhydride)

Examples of the tetracarboxylic dianhydride having a fluoroalkyl group include 4,4′-(hexafluoroisopropylidene)diphthalic anhydride, 2,2-bis[4-(3,4-dicarboxyphenoxy)phenyl]hexafluoropropane dianhydride, 1,4-bis(trifluoromethyl) pyromellitic dianhydride, 4-(trifluoromethyl)-1H,3H-benzo[1,2-c: 4,5-c′]difuran-1,3,5,7-tetron, 3,6-di[3′,5′-bis(trifluoromethyl)phenyl]pyromellitic dianhydride, and 1-(3′,5′-bis(trifluoromethyl)phenyl) pyromellitic dianhydride. Among them, 4,4′-(hexafluoroisopropylidene)diphthalic anhydride (6FDA) is particularly preferable from the viewpoint of achieving both transparency and mechanical strength of the polyimide.

### (Alicyclic Tetracarboxylic Dianhydride)

The alicyclic tetracarboxylic dianhydride is a tetracarboxylic dianhydride having an alicyclic structure. The alicyclic tetracarboxylic dianhydride preferably does not contain an aromatic ring and has an acid anhydride group bonded to an alicyclic ring from the viewpoint of the transparency of the polyimide and compatibility with the acryl-based resin.

Examples of the alicyclic tetracarboxylic dianhydride include 1,2,3,4-cyclobutanetetracarboxylic dianhydride, 1,2,3,4-cyclopentanetetracarboxylic dianhydride, 1,2,4,5-cyclohexanetetracarboxylic dianhydride, 1,1′-bicyclohexane-3,3′,4,4′-tetracarboxylic-3,4,3′,4′-dianhydride, norbornane-2-spiro-α-cyclopentanone-α′-spiro-2″-norbornane-5,5″,6,6″-tetracarboxylic dianhydride, and 2,2′-binorbornane-5,5′,6,6′-tetracarboxylic dianhydride. Among them, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA), and 1, l′-bicyclohexane-3,3′,4,4′-tetracarboxylic-3,4:3′,4′-dianhydride (H-BPDA) are preferred from the viewpoint of the transparency and mechanical strength of the polyimide, and among them, CBDA is particularly preferred.

### (Other Acid Dianhydrides)

The polyimide may contain a tetracarboxylic dianhydride other than those described above as the acid dianhydride component. Examples of the tetracarboxylic dianhydride other than those described above include aromatic tetracarboxylic dianhydrides containing no fluorine atom. When the polyimide contains a fluorine-free aromatic tetracarboxylic dianhydride, compatibility between the polyimide resin and the acryl-based resin is improved, and the mechanical strength of the film may be improved.

Examples of the fluorine-free aromatic tetracarboxylic dianhydride include acid dianhydrides in which two acid anhydride groups are bonded to one benzene ring, such as pyromellitic dianhydride and mellophanic dianhydride; acid dianhydrides in which two acid anhydride groups are bonded to one condensed polycyclic ring, such as 2,3,6,7-naphthalenetetracarboxylic 2,3:6,7-dianhydride, naphthalene-1,4,5,8-tetracarboxylic dianhydride, and terphenyltetracarboxylic dianhydride; and acid dianhydrides in which an acid anhydride group is bonded to different aromatic rings, such as bis(trimellitic anhydride) ester, 3,3′,4,4′-biphenyltetracarboxylic dianhydride, 3,3′,4,4′-benzophenonetetracarboxylic dianhydride, 4,4′-oxydiphthalic anhydride, 3,4′-oxydiphthalic anhydride, 3,3′,4,4′-diphenylsulfonetetracarboxylic dianhydride, 4,4′-(4,4′-isopropylidenediphenoxy)diphthalic anhydride, 5,5′-dimethylmethylenebis(phthalic anhydride), 9,9-bis(3,4-dicarboxyphenyl) fluorene dianhydride, 11,11-dimethyl-1H-difuro[3,4-b: 3′,4′-i]xanthene-1,3,7,9 (11H)-tetrone, 1,4-bis(3,4-dicarboxyphenoxy)benzene dianhydride, 4-(2,5-dioxotetrahydrofuran-3-yl)-1,2,3,4-tetrahydronaphthalene-1,2-dicarboxylic dianhydride, ethylene glycol bis(trimellitic anhydride), N,N′-(9H-fluoren-9-ylidenedi-4,1-phenylene)bis[1,3-dihydro-1,3-dioxo-5-isobenzofurancarboxamide], N,N′-[[2,2,2-trifluoro-1-(trifluoromethyl)ethylidene]bis(6-hydroxy-3,1-phenylene)]bis[1,3-dihydro-1,3-dioxo-5-isobenzofurancarboxamide], and 2,2-bis(4-hydroxyphenyl) propane dibenzoate-3,3′,4,4′-tetracarboxylic dianhydride.

Among them, pyromellitic dianhydride (PMDA), mellophanic dianhydride (MPDA), 3,3′4,4′-biphenyltetracarboxylic dianhydride (BPDA), 4,4′-oxydiphthalic anhydride (ODPA), 3,3′4,4′-benzophenonetetracarboxylic dianhydride (BTDA), 4′-(4,4′-isopropylidenediphenoxy)diphthalic anhydride (BPADA), 9,9-bis(3,4-dicarboxyphenyl) fluorene dianhydride (BPAF), and bis(trimellitic anhydride) ester are preferable as the fluorine-free tetracarboxylic dianhydride from the viewpoint of the transparency and solubility of the polyimide and compatibility with the acryl-based resin.

The bis(trimellitic anhydride) ester is represented by the following general formula (1).

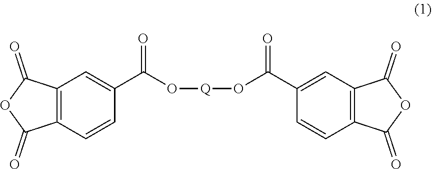

Q in general formula (1) is an arbitrary divalent organic group, and a carboxy group and a carbon atom of Q are bonded to each other at both ends of Q. The carbon atom bonded to the carboxy group may form a ring structure. Specific examples of the divalent organic group Q include the following (A) to (K).

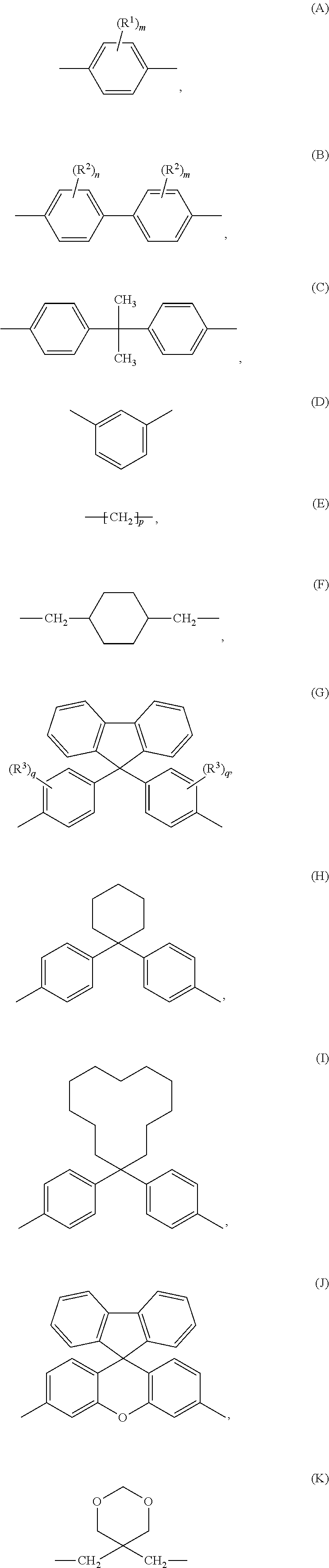

R¹ in formula (A) is an alkyl group having 1 to 20 carbon atoms, and m is an integer of 0 to 4. The group of formula (A) is a group obtained by removing two hydroxy groups from a hydroquinone derivative optionally having a substituent on a benzene ring. Examples of the hydroquinone having a substituent on a benzene ring include tert-butylhydroquinone, 2,5-di-tert-butylhydroquinone and 2,5-di-tert-amylhydroquinone. In the general formula (1), when Q is (A) and m is 0 (that is, there is no substituent on the benzene ring), bis(trimellitic anhydride) ester is p-phenylenebis(trimellitate anhydride) (abbreviation: TAHQ).

In formula (B), R² is an alkyl group having 1 to 20 carbon atoms, and n is an integer of 0 to 4. The group of formula (B) is a group obtained by removing two hydroxy groups from biphenol optionally having a substituent on a benzene ring. Examples of the biphenol derivative having a substituent on a benzene ring include 2,2′-dimethylbiphenyl-4,4′-diol, 3,3′-dimethylbiphenyl-4,4′-diol, 3,3′,5,5′-tetramethylbiphenyl-4,4′-diol and 2,2′,3,3′,5,5′-hexamethylbiphenyl-4,4′-diol.

The group of formula (C) is a group obtained by removing two hydroxy groups from 4,4′-isopropylidenediphenol (bisphenol A). The group of formula (D) is a group obtained by removing two hydroxy groups from resorcinol.

In formula (E), p is an integer of 1 to 10. The group of formula (E) is a group obtained by removing two hydroxy groups from a linear diol having 1 to 10 carbon atoms. Examples of the linear diol having 1 to 10 carbon atoms include ethylene glycol, and 1,4-butanediol.

The group of formula (F) is a group obtained by removing two hydroxy groups from 1,4-cyclohexanedimethanol.

In formula (G), R³ is an alkyl group having 1 to 20 carbon atoms, and q is an integer of 0 to 4. The group of formula (G) is a group obtained by removing two hydroxy groups from biphenol fluorene optionally having a substituent on a benzene ring having a phenolic hydroxy group. Examples of the bisphenol fluorene derivative having a substituent on a benzene ring having a phenolic hydroxy group include biscresol fluorene.

The bis(trimellitic anhydride) ester may be an aromatic ester. Among the above groups (A) to (K), groups (A), (B), (C), (D), (G), (H) and (I) are preferable as Q. Among them, the groups (A) to (D) are preferable, and the group (B) having a biphenyl backbone is particularly preferable. When Q is a group of general formula (B), Q may be 2,2′,3,3′,5,5′-hexamethylbiphenyl-4,4′-diyl of the following formula (B1) from the viewpoint of the solubility of the polyimide in an organic solvent.

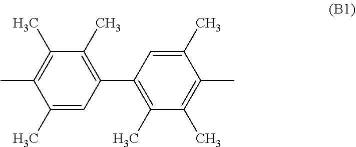

The acid dianhydride in which Q is a group of formula (B1) in general formula (1) is bis(1,3-dioxo-1,3-dihydroisobenzofuran-5-carboxylic acid)-2,2′,3,3′,5,5′-hexamethylbiphenyl-4,4′ diyl (abbreviation: TAHMBP) of the following formula (3).

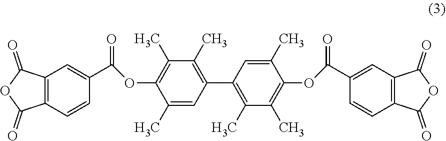

Examples of tetracarboxylic dianhydrides other than those described above include ethylenetetracarboxylic dianhydride and butanetetracarboxylic dianhydride.

### <Dicarboxylic Acid>

As described above, a dicarboxylic acid or a dicarboxylic acid derivative is used for preparation of a polyimide (polyamideimide) having an amide structure. Examples of the dicarboxylic acid include aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, 4,4′-biphenyl dicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, 1,3-cyclopentanedicarboxylic acid, and bi (cyclohexyl)-4,4′-dicarboxylic acid; and heterocyclic dicarboxylic acids such as 2,5-thiophene dicarboxylic acid and 2,5-furandicarboxylic acid.

Examples of the dicarboxylic acid derivative include dicarboxylic acid derivatives such as a dicarboxylic acid dichloride, a dicarboxylic acid ester, and a dicarboxylic anhydride. Among them, a dicarboxylic acid dichloride is preferable because of its high reactivity.

From the viewpoint of solubility of the polyamideimide and compatibility with the acryl-based resin, the dicarboxylic acid may be an aromatic dicarboxylic acid or an alicyclic dicarboxylic acid, or an aromatic dicarboxylic acid. Among aromatic dicarboxylic acids, terephthalic acid, isophthalic acid, 4,4′-biphenyl dicarboxylic acid, and 4,4′-oxybisbenzoic acid are preferred, and among these, terephthalic acid and isophthalic acid are preferred, and terephthalic acid is particularly preferred. Among alicyclic dicarboxylic acids, 1,4-cyclohexanedicarboxylic acid and bi (cyclohexyl)-4,4′-dicarboxylic acid are preferred, and 1,4-cyclohexanedicarboxylic acid is particularly preferred.

### <Composition of Polyimide>

The composition of the polyimide used in one or more embodiments is not particularly limited as long as it is soluble in an organic solvent and exhibits compatibility with the acryl-based resin, and as described above, the polyimide may be a polyamideimide having an amide bond derived from a dicarboxylic acid component.

In the polyimide, at least one of the diamine and the acid dianhydride may contain a fluoroalkyl group. Both a diamine containing a fluoroalkyl group and an acid dianhydride containing a fluoroalkyl group may be used. When at least one of the acid dianhydride and the diamine contains a fluoroalkyl group, solubility in an organic solvent and compatibility with the acryl-based resin tends to be improved.

In particular, the polyimide may contain a diamine having a fluoroalkyl group as the diamine component because the polyimide exhibits compatibility with the acryl-based resin in various solvents. As described above, the diamine having a fluoroalkyl group may be a fluoroalkyl-substituted benzidine such as TFMB.

The ratio of the diamine having a fluoroalkyl group to the total amount of the diamine components of the polyimide may be 50 mol % or more, 60 mol % or more, 70 mol % or more, 80 mol % or more, 85 mol % or more, or 90 mol % or more. The amount of the fluoroalkyl-substituted benzidine may be in the above range, and the amount of the TFMB may be in the above range. A large content of the fluoroalkyl-substituted benzidine such as TFMB tends to lead to suppression of coloring of the film, and enhancement of mechanical strength in terms of pencil hardness, tensile modulus and the like.

When the polyimide contains a diamine having no fluoroalkyl group as the diamine component, the diamine having no fluoroalkyl group may be a diamine having an alicyclic structure, a diamine having an ether structure, a diamine having a fluorene structure, a diamine having a sulfone group, or a diamine having a fluorine-containing group other than the fluoroalkyl group.

For example, by using diaminodiphenylsulfone as the diamine in addition to the fluoroalkyl-substituted benzidine, the solvent-solubility and transparency of the polyimide resin may be improved. On the other hand, when the proportion of diaminodiphenylsulfone is large, compatibility with the acryl-based resin may be reduced. The ratio of diaminodiphenylsulfone to the total amount of the diamine may be 1 to 40 mol %, 3 to 30 mol %, or 5 to 25 mol %.

The polyimide may contain at least one of an acid dianhydride having a fluoroalkyl group and an alicyclic tetracarboxylic dianhydride, as the acid dianhydride component, regardless of whether or not the polyimide contains a diamine having a fluoroalkyl group as the diamine component.

When the polyimide does not contain a diamine having a fluoroalkyl group as the diamine component, the polyimide may contain an acid dianhydride having a fluoroalkyl group as the acid dianhydride component from the viewpoint of imparting compatibility with the acryl-based resin. In this case, the ratio of the acid dianhydride having a fluoroalkyl group to the total amount of the acid dianhydride components of the polyimide may be 40 mol % or more, 50 mol % or more, 60 mol % or more, 70 mol % or more, 80 mol % or more, or 90 mol % or more. Among them, the amount of 6FDA may be in the above range.

When the polyimide contains a diamine having a fluoroalkyl group as the diamine component, the polyimide is not required to contain an acid dianhydride having a fluoroalkyl group as the acid dianhydride component. Even when the polyimide contains a diamine having a fluoroalkyl group as the diamine component, the polyimide may contain an acid dianhydride having a fluoroalkyl group as the acid dianhydride component.

From the viewpoint of enhancing the compatibility between the polyimide resin and the acryl-based resin, the ratio of the total amount of the fluoroalkyl group-containing aromatic tetracarboxylic dianhydride and the alicyclic tetracarboxylic dianhydride to the total amount of acid dianhydride components may be 15 mol % or more, 20 mol % or more, 25 mol % or more, 30 mol % or more, 40 mol % or more, 50 mol % or more, 60 mol % or more, 70 mol % or more, 80 mol % or more, or 90 mol % or more.

When the polyimide contains a diamine having a fluoroalkyl group as the diamine component and does not contain an acid dianhydride having a fluoroalkyl group as an acid dianhydride, the polyimide may contain an alicyclic tetracarboxylic dianhydride as the acid dianhydride component. The polyimide may contain a diamine having a fluoroalkyl group as the diamine component, and an acid dianhydride having a fluoroalkyl group and an alicyclic tetracarboxylic dianhydride as acid dianhydride components.

When the polyimide contains, as the acid dianhydride component, a fluoroalkyl group-containing tetracarboxylic dianhydride and does not contain an alicyclic tetracarboxylic dianhydride, the ratio of the fluoroalkyl group-containing tetracarboxylic dianhydride to the total amount of acid dianhydride components may be 30 mol % or more, 35 mol % or more, 40 mol % or more, 50 mol % or more, 60 mol % or more, 70 mol % or more, 80 mol % or more, or 90 mol % or more. The whole of the acid dianhydride components may be the fluoroalkyl group-containing tetracarboxylic dianhydride.

When the polyimide contains, as the acid dianhydride component, an alicyclic tetracarboxylic dianhydride and does not contain a fluoroalkyl group-containing tetracarboxylic dianhydride, the ratio of the alicyclic tetracarboxylic dianhydride to the total amount of the acid dianhydride components may be 15 mol % or more, 20 mol % or more, 25 mol % or more or 30 mol % or more.

When the polyimide contains, as the acid dianhydride component, a fluoroalkyl group-containing tetracarboxylic dianhydride and an alicyclic tetracarboxylic dianhydride, the ratio of the total amount of the fluoroalkyl group-containing tetracarboxylic dianhydride and the alicyclic tetracarboxylic dianhydride to the total amount of the acid dianhydride components may be 20 mol % or more, 25 mol % or more, 30 mol % or more, 35 mol % or more, 40 mol % or more, 50 mol % or more, 60 mol % or more, 70 mol % or more, 80 mol % or more, or 90 mol % or more.

The ratio of the alicyclic tetracarboxylic dianhydride to the total amount of the acid dianhydride components may be 80 mol % or less, 70 mol % or less, 65 mol % or less, 60 mol % or less, 55 mol % or less, or 50 mol % or less from the viewpoint of ensuring the solubility of the polyimide resin in an organic solvent regardless of whether or not the polyimide contains the fluoroalkyl group-containing tetracarboxylic dianhydride as the acid dianhydride component. In order for the acryl-based resin and the polyimide resin to be compatible with each other even in a low-boiling-point non-amide-based solvent (for example, a halogen-based solvent such as methylene chloride), the ratio of the alicyclic tetracarboxylic dianhydride to the total amount of the acid dianhydride components of the polyimide may be 45 mol % or less, 40 mol % or less, or 35 mol % or less. The ratio of the alicyclic tetracarboxylic dianhydride to the total amount of the acid dianhydride components of the polyimide may be 1 mol % or more, 5 mol % or more, 10 mol % or more, 15 mol % or more, or 20 mol % or more.

When the polyimide contains an alicyclic tetracarboxylic dianhydride as the acid dianhydride component, in order for the polyimide resin and the acryl-based resin to be compatible with each other in the organic solvent, the polyimide may contain, as the acid dianhydride component, a fluoroalkyl group-containing tetracarboxylic dianhydride and/or a fluorine-free aromatic tetracarboxylic dianhydride in addition to the alicyclic tetracarboxylic dianhydride. As described above, the alicyclic tetracarboxylic dianhydride may be CBDA, the fluoroalkyl group-containing tetracarboxylic dianhydride may be 6FDA, and the fluorine-free aromatic tetracarboxylic dianhydride may be PMDA, MPDA, BPDA, ODPA, BTDA, BPADA, BPAF, or bis(trimellitic anhydride) ester. The bis(trimellitic anhydride) ester may be TAHQ or TAHMBP, or TAHMBP.

When the polyimide contains a fluoroalkyl group-containing tetracarboxylic dianhydride as the acid dianhydride component, the polyimide resin and the acryl-based resin are compatible in the organic solvent even if the whole of the acid dianhydrides is the fluoroalkyl group-containing tetracarboxylic dianhydride. In order for the acryl-based resin and the polyimide resin to be compatible with each other even in a low-boiling-point non-amide-based solvent (for example, a halogen-based solvent such as methylene chloride), the ratio of the fluoroalkyl group-containing tetracarboxylic dianhydride to the total amount of the acid dianhydride components of the polyimide may be 90 mol % or less, 85 mol % or less, 80 mol % or less, 70 mol % or less, 65 mol % or less, or 60 mol % or less.

When the polyimide contains, as the acid dianhydride component, a fluoroalkyl group-containing tetracarboxylic dianhydride and does not contain an alicyclic tetracarboxylic dianhydride, in order for the acryl-based resin and the polyimide resin to be compatible with each other in the low-boiling-point non-amide-based solvent, the ratio of the fluoroalkyl group-containing tetracarboxylic dianhydride to the total amount of the acid dianhydride components may be 30 to 90 mol %, 35 to 80 mol %, or 40 to 75 mol %. From the same viewpoint, the ratio of the fluorine-free aromatic tetracarboxylic dianhydride to the total amount of the acid dianhydride components may be 10 to 70 mol %, 20 to 65 mol %, or 25 to 60 mol %. As described above, the fluoroalkyl group-containing tetracarboxylic dianhydride may be 6FDA, and the fluorine-free aromatic tetracarboxylic dianhydride may be PMDA, MPDA, BPDA, ODPA, BTDA, BPADA, BPAF, or bis(trimellitic anhydride) ester. The bis(trimellitic anhydride) ester may be TAHQ or TAHMBP, or TAHMBP.

When the polyimide contains a dicarboxylic-acid-derived structure represented by the general formula (Va), that is, when the polyimide is polyamideimide, the total of the tetracarboxylic-dianhydride-derived structure represented by general formula (IIIa) and the dicarboxylic-acid-derived structure represented by the general formula (Va) may be 90 to 110 parts by mol per 100 parts by mol of the diamine-derived structure represented by the general formula (IIa). The total of the structure of the general formula (IIa) and the structure of the general formula (Va) may be 93 to 107 parts by mol, 95 to 105 parts by mol, 97 to 103 parts by mol, or 99 to 101 parts by mol per 100 parts by mol of the structure of the general formula (IIa).

In the polyamideimide, the ratio of the structure of the general formula (Va) to the total of the structure of the general formula (IIIa) and the structure of the general formula (Va) may be 1 to 70 mol %, 2 to 60 mol %, 3 to 50 mol %, 5 to 45 mol % or 10 to 40 mol %. The ratio between the structure of the general formula (II) and the structure of the general formula (Va) is almost the same as the ratio between the imide structure of the general formula (I) and the amide structure of the general formula (IV). The solubility of the polyamideimide in the organic solvent tends to improve as the proportion of the dicarboxylic-acid-derived structure of the general formula (Va) increases, that is, as the proportion of the amide structure increases. When the proportion of the dicarboxylic-acid-derived structure of the general formula (Va) is 70 mol % or less, excellent compatibility with the acryl-based resin can be exhibited. From the viewpoint of compatibility with the acryl-based resin and the mechanical strength of the film, the proportion of the dicarboxylic-acid-derived structure may be 50 mol % or less.

As described above, the dicarboxylic acid component of the polyamideimide may be terephthalic acid, isophthalic acid, 4,4′-biphenyldicarboxylic acid, 4,4′-oxybisbenzoic acid, 1,4-cyclohexanedicarboxylic acid, or bi (cyclohexyl)-4,4′-dicarboxylic acid. Among these, terephthalic acid and isophthalic acid are preferred, and terephthalic acid is particularly preferred.

The polyamideimide may contain, as a dicarboxylic acid component, at least one of these dicarboxylic acids. The ratio of the total amount of terephthalic acid, isophthalic acid, 4,4′-biphenyldicarboxylic acid, 4,4′-oxybisbenzoic acid, 1,4-cyclohexanedicarboxylic acid, and bi (cyclohexyl)-4,4′-dicarboxylic acid to the total amount of dicarboxylic acid components in the polyamideimide may be 50 mol % or more, 60 mol % or more, 70 mol % or more, 75 mol % or more, 80 mol % or more, 85 mol % or more, 90 mol % or more, or 95 mol % or more. The ratio of the total amount of terephthalic acid and isophthalic acid to the total amount of dicarboxylic acid components in the polyamideimide may be 50 mol % or more, 60 mol % or more, 70 mol % or more, 75 mol % or more, 80 mol % or more, 85 mol % or more, 90 mol % or more, or 95 mol % or more, and the amount of terephthalic acid may be within the above range.

Even when the polyimide is a polyamideimide having a dicarboxylic-acid-derived structure represented by the general formula (Va), at least one of the diamine and the acid dianhydride may have a fluoroalkyl group from the viewpoint of solubility in the organic solvent and compatibility with the acryl-based resin. The polyamideimide may contain a diamine having a fluoroalkyl group as the diamine component, and may contain a fluoroalkyl-substituted benzidine such as TFMB.

The ratio of the amount of the fluoroalkyl-substituted benzidine to the total amount of diamine components in the polyamideimide may be 30 mol % or more. In other words, 30% or more of the diamine residues Y contained in the polyamideimide may be structural units obtained by substituting at least one of hydrogen atoms on the benzene rings of 4,4′-biphenylene with a fluoroalkyl group. The ratio of the amount of the diamine having a fluoroalkyl group to the total amount of diamine components in the polyamideimide may be 50 mol % or more, 70 mol % or more, 80 mol % or more, 85 mol % or more, or 90 mol % or more. Particularly preferably, the ratio of the amount of TFMB to the total amount of diamine components is within the above range.

Even when the polyimide is a polyamideimide containing a dicarboxylic-acid-derived structure represented by the general formula (Va), the polyimide may contain, as the acid dianhydride component, at least one of an acid dianhydride having a fluoroalkyl group and an alicyclic tetracarboxylic dianhydride from the viewpoint of solubility in the organic solvent and compatibility with the acryl-based resin.

### <Preparation of Polyimide>

A method for preparing the polyimide is not limited. In general, a polyamic acid as a polyimide precursor is prepared by a reaction between a diamine and a tetracarboxylic dianhydride, and a polyimide is obtained by dehydration and cyclization (imidization) of the polyamic acid.

The method for preparing a polyamic acid solution is not particularly limited, and any known method can be applied. For example, diamine and tetracarboxylic dianhydride are dissolved in an organic solvent in substantially equimolar amounts (molar ratio=95:100 to 105:100), and the solution is stirred to obtain a polyamic acid solution. The concentration of the polyamic acid solution may be typically 5 to 35 wt %, or 10 to 30 wt %. When the concentration is in this range, the polyamic acid obtained by polymerization has an appropriate molecular weight, and the polyamic acid solution has an appropriate viscosity.

When the polyamideimide is prepared, the polyamideimide may be prepared using a dicarboxylic acid or a derivative thereof (dicarboxylic acid dichloride, dicarboxylic anhydride, and the like) as a monomer in addition to the diamine and the tetracarboxylic dianhydride. In this case, the amount of each of the monomers should be adjusted so that the total amount of the tetracarboxylic dianhydride and the dicarboxylic acid or the derivative thereof is almost equimolar to the amount of the diamine.

In polymerization of the polyamic acid, a method is preferable in which an acid dianhydride and a dicarboxylic acid or a derivative thereof is added to a diamine for suppressing ring opening of the acid dianhydride. When a plurality of types of diamines, a plurality of types of acid dianhydrides, a plurality of types of dicarboxylic acids or derivatives thereof are added, they may be added at one time, or may be added in several portions. By adjusting the order of adding the monomers, various physical properties of the polyimide can be controlled.

The polyamic acid may be prepared by a polymerization method in which some of the monomers are previously polymerized to prepare an oligomer, and the residual monomer is added to the oligomer. An example of the oligomer is the above-described amine-terminated oligomer.

The organic solvent used for polymerization of the polyamic acid is not particularly limited as long as it does not react with monomers and can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N′-diethylacetamide, N-methyl-2-pyrrolidone (NMP), γ-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are normally used alone, or if necessary, two or more thereof are used in combination as appropriate. From the viewpoint of the solubility and polymerization reactivity of the polyamic acid, DMAc, DMF, NMP, and the like may be used.

A polyimide can be obtained by cyclodehydration of the polyamic acid. Examples of the method for preparing a polyimide from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing a polyimide generated by imidization of the polyamic acid, a polyimide resin is precipitated as a solid. By isolating the polyimide resin as a solid substance, impurities generated during synthesis of the polyamic acid, and the residual dehydration agent and the imidization catalyst and the like can be washed and removed with the poor solvent, so that it is possible to prevent coloring of the polyimide and an increase in yellowness. By isolating the polyimide resin as a solid, a solvent suitable for forming a film, such as a low-boiling-point solvent, can be applied in preparation of a solution for producing a film.

The molecular weight (weight average molecular weight in terms of polyethylene oxide which is measured by gel filtration chromatography (GPC)) of the polyimide may be 10,000 to 300,000, 20,000 to 250,000, or 40,000 to 200,000. An excessively small molecular weight may result in insufficient strength of the film. An excessively large molecular weight may result in poor compatibility with the acryl-based resin.

The polyimide resin may be soluble in non-amide-based solvents such as ketone-based solvents and halogenated alkyl-based solvents. The phrase “the polyimide resin exhibits solubility in a solvent” means that the polyimide resin is dissolved at a concentration of 5 wt % or more. In one or more embodiments, the polyimide has solubility in methylene chloride. Methylene chloride has a low boiling point, so that it is easy to remove the residual solvent during production of the film. Therefore, the use of a polyimide resin soluble in methylene chloride can be expected to improve productivity of the film.

From the viewpoint of the heat stability and light stability of the resin composition and the film, it is preferable that the polyimide has low reactivity. The acid value of the polyimide may be 0.4 mmol/g or less, 0.3 mmol/g or less, or 0.2 mmol/g or less. The acid value of the polyimide may be 0.1 mmol/g or less, 0.05 mmol/g or less, or 0.03 mmol/g or less. The imidization ratio of the polyimide may be 93% or more, 95% or more, 97% or more, 98% or more, or 99% or more. From the viewpoint of reducing the acid value, it is preferable that the polyimide has a high imidization ratio. A small acid value tends to lead to enhancement of the stability of the polyimide, and improvement of compatibility with the acryl-based resin.

### [Acryl-Based Resin]

Examples of the acryl-based resin include poly(meth) acrylic acid esters such as polymethyl methacrylate, methyl methacrylate-(meth) acrylic acid copolymers, methyl methacrylate-(meth) acrylic acid ester copolymers, methyl methacrylate-acrylic acid ester-(meth) acrylic acid copolymers, and methyl (meth)acrylate-styrene copolymers. The tacticity of the polymer is not particularly limited, and may be any of an isotactic type, a syndiotactic type and an atactic type.

From the viewpoint of transparency, compatibility with polyamideimide, and mechanical strength of a film, it is preferable that the acryl-based resin has methyl methacrylate as a main structural unit. The amount of methyl methacrylate based on the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate.

In the acryl-based resin, an imide structural unit or a lactone ring structural unit may be introduced as described above. Such a modified polymer may be one obtained by introducing an imide structure or a lactone ring structure into an acrylic polymer whose methyl methacrylate content is in the above-described range. That is, in the acryl-based resin modified by introduction of an imide structure or a lactone ring structure, the total amount of methyl methacrylate and modified structures of methyl methacrylate may be 60 wt % or more, 70 wt % or more, 80 wt % or more, 85 wt % or more, 90 wt % or more, or 95 wt % or more. The modified polymer may be one obtained by introducing an imide structure or a lactone ring structure into a homopolymer of methyl methacrylate.

Introduction of an imide structure into an acryl-based polymer such as methyl methacrylate tends to lead to improvement of the glass transition temperature of the acryl-based resin. When the acryl-based resin includes an imide structure, compatibility with the polyimide may be improved. For example, a polyamideimide having a large proportion of the dicarboxylic-acid-derived structure (a proportion of the amide structure) may have poor compatibility with the acryl-based resin, while an acryl-based resin having an imide structure can exhibit excellent compatibility with the polyamideimide having a high proportion of the dicarboxylic-acid-derived structure.

An acryl-based resin having a glutarimide structure is obtained by, for example, heating and melting a polymethyl methacrylate resin and performing treatment with an imidizing agent as described in Japanese Patent Laid-open Publication No. 2010-261025. As such imide-modified polymethyl methacrylate, a commercially-available product such as “PLEXIMID TT70” or “PLEXIMID 8805” manufactured by EVONIK may be used.

When the acryl-based resin has a glutarimide structure, the glutarimide content may be 3 wt % or more, 10 wt % or more, 20 wt % or more, 30 wt % or more, or 50 wt % or more. The acryl-based resin having a higher glutarimide content is more likely to have compatibility also with the polyamideimide having a high proportion of the structure of the general formula (Va) (a high proportion of the amide structure).

The glutarimide content is calculated by determining the ratio of introduction of the glutarimide structure (imidization ratio) from a 1H-NMR spectrum of the acryl-based resin and converting the imidization ratio to a weight basis. For example, in methyl methacrylate into which a glutarimide structure has been introduced, the imidization ratio Im=B/(A+B) is determined, where A is an area of a peak originating from O—CH₃ protons of methyl methacrylate (around 3.5 to 3.8 ppm) and B is an area of a peak originating from N—CH₃ protons of glutarimide (around 3.0 to 3.3 ppm).

From the viewpoint of the heat resistance of the resin composition and the film, the glass transition temperature of the acryl-based resin may be 80° C. or higher, 90° C. or higher, 100° C. or higher, 100° C. or higher, 115° C. or higher, or 120° C. or higher.

From the viewpoint of solubility in an organic solvent, compatibility with the polyamideimide and film strength, the weight average molecular weight of the acryl-based resin (in terms of polystyrene) may be 5,000 to 5,000,000, 10,000 to 2,000,000, 15,000 to 1,000,000, 20,000 to 500,000, 30,000 to 300,000, or 50,000 to 200,000.

From the viewpoint of the heat stability and light stability of the resin composition and the film, it is preferable that the content of reactive functional groups such as ethylenically unsaturated groups and carboxy groups in the acryl-based resin is small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin, and improvement of compatibility with the polyimide.

### [Resin Composition]

The polyimide resin and the acryl-based resin are blended to prepare a resin composition. Since the polyimide resin and the acryl-based resin at an arbitrary ratio can be compatible with each other, the ratio between the polyimide resin and the acryl-based resin in the resin composition is not particularly limited. The blending ratio (weight ratio) of the polyimide resin to the acryl-based resin may be 98:2 to 2:98, 95:5 to 10:90, or 90:10 to 15:85. As the proportion of the polyimide resin is higher, the tensile modulus and pencil hardness of the film are higher, the mechanical strength is excellent, and improvement in the tensile modulus and bending resistance by stretching tends to be remarkable. As the proportion of the acryl-based resin is higher, the film is less colored, thus has higher transparency, and also has lower glass transition temperature, so that processability such as stretching of the film tends to be improved.

In order to sufficiently exhibit the effect of improving transparency and processability by mixing the polyimide resin with the acryl-based resin, the proportion of the acryl-based resin in the total of the polyimide resin and the acryl-based resin may be 10 wt % or more, 15 wt % or more, 20 wt % or more, 25 wt % or more, 30 wt % or more, 35 wt % or more, 40 wt % or more, 45 wt % or more, 50 wt % or more, 60 wt % or more, or 70 wt % or more. On the other hand, from the viewpoint of obtaining a film having excellent mechanical strength, the proportion of the polyimide resin in the total of the polyimide resin and the acryl-based resin may be 10 wt % or more, 20 wt % or more, 30 wt % or more, 40 wt % or more, 50 wt % or more, 60 wt % or more, 65 wt % or more, 70 wt % or more, 75 wt % or more, or 80 wt % or more.

The polyimide is a polymer having a special molecular structure, and generally has low solubility in an organic solvent and is not compatible with other polymers. As described above, the polyimide containing specific diamine component and acid dianhydride component exhibits high solubility in an organic solvent and compatibility with the acryl-based resin.

It is preferable that a resin composition containing the polyimide resin and the acryl-based resin has a single glass transition temperature in differential scanning calorimetry (DSC) and/or dynamic mechanical analysis (DMA). When the resin composition has a single glass transition temperature, it can be considered that the polyimide resin and the acryl-based resin are completely compatible with each other. It is preferable that a film containing the polyimide resin and the acryl-based resin has a single glass transition temperature.

From the viewpoint of heat resistance, the glass transition temperature of the resin composition and the film may be 110° C. or higher, 115° C. or higher, 120° C. or higher, 125° C. or higher, 130° C. or higher, 135° C. or higher, 140° C. or higher, 145° C. or higher, or 150° C. or higher. On the other hand, from the viewpoint of processability such as stretching, the glass transition temperature of the resin composition and the film may be lower than 250° C., 240° C. or lower, 230° C. or lower, 220° C. or lower, or 210° C. or lower.

The resin composition may be one obtained by simply mixing a polyimide resin and an acryl-based resin precipitated as a solid content, or may be one obtained by kneading a polyimide resin and an acryl-based resin. When the polyimide solution is mixed with a poor solvent to precipitate the polyimide resin, an acryl-based resin may be mixed with the solution to precipitate a resin composition in which the polyimide and the acryl-based resin are mixed as a solid (powder).

The resin composition may be a mixed solution containing a polyimide resin and an acryl-based resin. The method for blending the resins is not particularly limited, and the resins may be mixed in a solid state, or may be mixed in a liquid to form a mixed solution. The polyimide solution and the acryl-based resin solution may be individually prepared, and mixed to prepare a mixed solution of the polyimide and the acryl-based resin.

The solvent of a solution containing the polyimide resin and the acryl-based resin is not particularly limited as long as it exhibits an ability to dissolve both the polyimide resin and the ester-based resin. Examples of the solvent include amide-based solvents such as N,N-dimethylformamide, N,N-dimethylacetamide, and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl solvents such as chloroform, 1,2-dichloroethane, 1,1,2,2-tetrachloroethane, chlorobenzene, dichlorobenzene, and methylene chloride.

From the viewpoint of the solubility of the polyimide resin and the compatibility between the polyimide resin and the acryl-based resin in the solution, amide-based solvents are preferable. On the other hand, low-boiling-point non-amide-based solvents are preferable from the viewpoint of solvent removability in production of a formed a film, and ketone-based solvents and halogenated alkyl-based solvents are preferable because they are excellent in ability to dissolve a polyimide resin as well as an acryl-based resin, and have a low boiling point, so that it is easy to remove the residual solvent during production of a film.

For the purpose of, for example, improving the processability of the film and imparting various functions, an organic or inorganic low-molecular-weight compound, a high-molecular-weight compound (for example, epoxy resin) or the like may be blended in the resin composition (solution). The resin composition may contain a flame retardant, an ultraviolet absorber, a crosslinking agent, a dye, a pigment, a surfactant, a leveling agent, a plasticizer, fine particles, a sensitizer, and the like. The fine particles include organic fine particles such as those of polystyrene and polytetrafluoroethylene, and inorganic fine particles such as those of colloidal silica, carbon and layered silicate, and may have a porous or hollow structure. Fiber reinforcement materials include carbon fibers, glass fibers, and aramid fibers.

### [Film]

### <Film Formation>

A film containing a polyimide resin and an acryl-based resin can be produced by a known method such as a melting method or a solution method. As described above, the polyimide resin and the acryl-based resin may be mixed in advance, or may be mixed at the time of film formation. A compound obtained by kneading the polyimide resin and the acryl-based resin may be used.

A resin composition containing a polyimide resin and an acryl-based resin tends to have a melt viscosity lower than that of a polyimide resin alone, and is excellent in moldability in melt extrusion molding and the like. A solution of a resin composition containing a polyimide and an acryl-based resin tends to have a solution viscosity lower than that of a solution of a polyimide alone, which has the same solid concentration. Therefore, the solution is excellent in handling properties such as transportability, and has a high coating property, which is advantageous in suppression of unevenness in thickness of the film, and the like.

As described above, the method for forming the film may be either a melting method or a solution method, and a solution method is preferable from the viewpoint of producing a film excellent in transparency and uniformity. In the solution method, a solution containing the polyimide resin and the acryl-based resin is applied onto a support, and the solvent is removed by drying to obtain a film.

As a method for applying the resin solution onto the support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in a deposition dope solvent may be appropriately selected.

It is preferable to perform heating the solvent during drying. The heating temperature is not particularly limited as long as the solvent can be removed and coloring of the resulting film can be suppressed, and the temperature is appropriately set to room temperature to about 250° C., and may be 50° C. to 220° C. The heating temperature may be elevated stepwise. After drying proceeds to some extent, the resin film may be peeled off from the support and dried for enhancing the solvent removal efficiency. For accelerating the removal of the solvent, heating may be performed under reduced pressure.

### <Stretching>

A film immediately after film formation (in the case of the solution method, after drying a solvent) is an unstretched film, and generally has no refractive index anisotropy. By stretching the film in at least one direction, the in-plane refractive index anisotropy of the film tends to increase, and the mechanical strength of the film tends to be improved.

The stretching conditions of the film are not particularly limited, and a method of stretching the film in the conveying direction between a pair of nip rolls having different peripheral speeds (free-end uniaxial stretching), a method of fixing both ends of the film in the width direction with pins or clips and stretching the film in the width direction (fixed-end uniaxial stretching), or the like can be employed. Biaxial stretching may also be performed, such as sequential biaxial stretching in which free-end uniaxial stretching is performed and then fixed-end uniaxial stretching is performed, or simultaneous biaxial stretching in which the film is stretched in the conveying direction and the width direction in a state in which both ends of the film in the width direction are fixed.

In order to obtain a film in which a difference in the in-plane refractive index n₁-n₂ (in-plane birefringence) is small and a difference n_{H}−n₃ (out-of-plane birefringence) between the in-plane average refractive index n_{H} and the thickness direction refractive index n₃ is large, biaxial stretching is preferable. In biaxial stretching, a stretching ratio in one direction and a stretching ratio in a direction perpendicular thereto may be the same or different. By reducing a difference between the stretching ratio in one direction and the stretching ratio in the direction perpendicular thereto, n₁-n₂ tends to decrease.

The film containing a polyimide resin and an acryl-based resin generally tends to have a large refractive index in the stretching direction. In a compatible system of the polyimide resin and the acryl-based resin, the tensile modulus in the stretching direction of the film increases, and the increase in the tensile modulus is remarkable when the stretching ratio is increased. By stretching the film, bending resistance in the stretching direction (bending resistance when a direction orthogonal to the stretching direction is a bending axis) tends to be improved.

In the direction orthogonal to the stretching direction, the tensile modulus tends to be smaller than that before stretching (unstretched film). When the film is biaxially stretched, both the refractive index n₁ in one direction in the film plane and the refractive index n₂ in the direction orthogonal thereto become larger than those before stretching, and the thickness direction refractive index n₃ becomes smaller. Accordingly, the tensile modulus in all directions in the film plane increases, and a film having high bending resistance can be obtained regardless of which direction is set as a bending axis.

The heating temperature during stretching is not particularly limited, and may be set, for example, within a range of about +40° C. of the glass transition temperature of the film. As the stretching temperature is lower, the refractive index anisotropy of the film tends to increase. In addition, as the stretching ratio increases, the refractive index anisotropy of the film tends to increase.

The stretching temperature may be lower than 250° C., 245° C. or lower, 240° C. or lower, 230° C. or lower, 225° C. or lower, 220° C. or lower, 215° C. or lower, 210° C. or lower, 205° C. or lower, 200° C. or lower, 195° C. or lower, or 190° C. or lower from the viewpoint of suppressing coloring of the film due to heating during stretching and obtaining a film having high transparency (low yellowness). The compatible resin composition of the polyimide resin and the acryl-based resin has a glass transition temperature lower than that of the polyimide resin alone, and thus has good stretching processability even at a temperature lower than 250° C.

The stretching temperature may be 100° C. or higher, 110° C. or higher, 120° C. or higher, 130° C. or higher, 140° C. or higher, 150° C. or higher, 160° C. or higher, 170° C. or higher, or 180° C. or higher from the viewpoint of suppressing the increase in the haze of the film due to stretching.

The stretching ratio may be set so that the out-of-plane birefringence n_{H}−n₃ is 0.0140 or more. The stretching ratio may be, for example, 1 to 300%, or may be 5% or more, 10% or more, 30% or more, 50% or more, 70% or more, 90% or more, or 120% or more, and may be 250% or less, 200% or less, or 150% or less. The stretching ratio (%) is represented by 100×(L₁−L₀)/L₀, where L₀ is the length (original length) of the film before stretching in the stretching direction, and L₁ is the length of the film after stretching in the stretching direction. In biaxial stretching, n_{H}−n₃ tends to increase at a stretching ratio smaller than that in uniaxial stretching.

### [Properties of Film]

The thickness of the film is not particularly limited, and may be appropriately set according to a use purpose. The thickness of the film (after stretched) is, for example, 5 to 300 μm. From the viewpoint of achieving both self-supporting properties and flexibility and obtaining a film having high transparency, the thickness of the film may be 20 μm to 100 μm, 30 μm to 90 μm, 40 μm to 85 μm, or 50 μm to 80 μm. The thickness of the film which is used as a cover film for a display may be 30 μm or more, 40 μm or more, or 50 μm or more.

As described above, the film after stretching has refractive index anisotropy, and a difference n_{H}−n₃ between an in-plane average refractive index n_{H} and a thickness direction refractive index n₃ is 0.0140 or more. The in-plane average refractive index n_{H} is an average value of a refractive index n₁ in a first direction in which the in-plane refractive index is maximum and a refractive index n₂ in a second direction orthogonal to the first direction in the film plane.

The direction (first direction) in which the in-plane refractive index is maximum is determined using a retardation meter. The slow axis direction determined by retardation measurement is the first direction. The refractive index n₁ in the first direction, the refractive index n₂ in the second direction, and the thickness direction refractive index n₃ are measured values by a prism coupler method. The thickness direction refractive index n₃ is an average value of refractive indexes in the thickness direction in a cross section perpendicular to the first direction and a cross section perpendicular to the second direction.

The out-of-plane birefringence n_{H}−n₃, which is a difference between the in-plane average refractive index n_{H} and the thickness direction refractive index n₃, tends to increase as the stretching ratio increases and the molecular orientation in the in-plane direction of the film increases. n_{H}−n₃ may be 0.0145 or more, 0.0150 or more, 0.0155 or more, or 0.0160 or more, and may be 0.018 or more, 0.020 or more, 0.022 or more, 0.024 or more, or 0.025 or more. n_{H}−n₃ may be 0.080 or less, 0.060 or less, 0.050 or less, or 0.045 or less.

An index R (%) of the in-plane refractive index anisotropy: 100×(n₁−n₂)/n₂ may be less than 1.0%, 0.9% or less, 0.8% or less, 0.7% or less, or 0.6% or less. As R is smaller, the in-plane anisotropy of the mechanical strength is smaller, and excellent mechanical strength tends to be exhibited in all directions in the film plane. As described above, biaxially stretching the film tends to reduce the in-plane refractive index anisotropy, and as the difference in the stretching ratio in one direction and the stretching ratio in the direction perpendicular thereto decreases, R tends to decrease.

The total light transmittance of the film may be 85% or more, 86% or more, 87% or more, 88% or more, 89% or more, 90% or more, or 91% or more. The haze of the film may be 10% or less, 5% or less, 4% or less, 3.5% or less, 3% or less, 2% or less, or 1% or less. In the compatible system of the polyimide resin and the acryl-based resin, high transparency is maintained even when stretching is performed so that n_{H}−n₃ is 0.0140 or more. and thus a transparent film having a high total light transmittance and a low haze is obtained.

The yellowness index (YI) of the film may be 5.0 or less, 4.0 or less, 3.0 or less, 2.0 or less, 1.5 or less, or 1.0 or less. By mixing the polyimide resin with the acryl-based resin, a film is obtained which is less colored and has smaller YI as compared to a case where the polyimide resin is used alone. In addition, the compatible resin composition of the polyimide resin and the acryl-based resin has a lower glass transition temperature than that of the polyimide resin alone. Therefore, a film can be stretched at a low temperature, and coloring of the film due to heating during stretching is suppressed, so that a stretched film having a small YI can be obtained.

From the viewpoint of the strength, the tensile modulus in the first direction and the tensile modulus in the second direction may be both 3.5 GPa or more. The tensile modulus in each of the first direction and the second direction may be 3.7 GPa or more, 3.9 GPa or more or 4.0 GPa or more. The difference between the tensile modulus in the first direction and the tensile modulus in the second direction may be 2.0 GPa or less, 1.5 GPa or less, 1.2 GPa or less, 1.0 GPa or less, 0.8 GPa or less, 0.6 GPa or less, or 0.5 GPa or less. The difference in tensile modulus between the first direction and the second direction tends to decrease by biaxial stretching.

An unstretched film made of a resin composition containing a polyimide resin and an acryl-based resin has a tensile modulus smaller than that of a film made of a polyimide resin alone. However, when a film made of the compatible system of the polyimide resin and the acryl-based resin is stretched, the tensile modulus is remarkably increased. Therefore, it is possible to realize a high tensile modulus comparable to or higher than that of the film made of a polyimide resin alone.

The pencil hardness of the film may be equal to or greater than F, equal to or greater than H, or equal to or greater than 2H. In the compatible system of the polyimide resin and the acryl-based resin, the pencil hardness hardly decreases even if the proportion of the acryl-based resin is increased, and thus the pencil hardness does not change greatly even if stretching is performed. Therefore, it is possible to obtain a film which is less colored and excellent in transparency while the excellent mechanical strength characteristic of a polyimide is not reduced.

When a dynamic bending test involving repeatedly bending a film under conditions of a bending radius of 1.0 mm, a bending angle of 180°, and a bending speed of 1 time/second is performed, the endurable number of cycles (the number of bending times until the film is cracked or broken) may be 100,000 times or more, 150,000 times or more or 200,000 times or more. Since the bending resistance in the stretching direction is improved by stretching the film, the endurable number of cycles when the dynamic bending test is performed with a direction orthogonal to the stretching direction as the bending axis is significantly larger than the endurable number of cycles of an unstretched film.

In the film, the endurable number of cycles when a dynamic bending test is performed with the second direction as a bending axis may be within the above range, and the endurable number of cycles may be within the above range in both the case where the first direction is the bending axis and the case where the second direction is the bending axis. Since a biaxially stretched film has high mechanical strength in all directions in the film plane, the biaxially stretched film can exhibit a large endurable number of cycles regardless of which direction is set as the bending axis.

### [Application of Film]

The above-described film has high transparency and excellent mechanical strength, and thus is suitably used for cover films disposed on a surface on the viewing side of image display panels, transparent substrates for displays, transparent substrates for touch panels, substrates for solar cells, and the like. When the film is put into practical use, a surface of the film may be provided with an antistatic layer, an easily bondable layer, a hard coat layer, an antireflection layer and the like.

The above-described film has high bending resistance, and thus can be particularly suitably used as cover films disposed on a surface on the viewing side of curved screen displays or foldable displays. The above-described film may also be suitably used as a cover film of a foldable image display device (foldable display), which is repeatedly bent along a bending axis at the same position.

### EXAMPLES

Hereinafter, one or more embodiments of the present invention will be described in further detail by showing examples. One or more embodiments of the present invention are not limited to examples below.

### [Polyimide Resin Production Examples]

Dimethylformamide (DMF) was added into a separable flask, and stirred in a nitrogen atmosphere. Diamine and tetracarboxylic dianhydride were added at a ratio (%) as shown in Table 1, and the mixture was reacted by stirring in a nitrogen atmosphere for 5 to 10 hours to obtain a polyamic acid solution having a solid content concentration of 18 wt %.

To 100 g of the polyamic acid solution, 6.0 g of pyridine as an imidization catalyst was added, and completely dispersed, 8 g of acetic anhydride was then added, and the mixture was stirred at 90° C. for 3 hours. The solution was cooled to room temperature, and 100 g of 2-propyl alcohol (hereinafter, referred to as “IPA”) was then added dropwise at a rate of 2 to 3 drops/see while the solution was stirred, thereby precipitating a polyimide. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours to obtain polyimide resins A to C.

### [Preparation of Polyamideimide Resin]

A diamine, a tetracarboxylic dianhydride, and a dicarboxylic acid dichloride were added at the ratios (mol %) shown in Table 1. Polyimide resins D to G were obtained by performing polymerization (preparation of polyamic acid solution), imidization; precipitation, washing, and drying of resin, in the same manner as in preparation of the polyimide resin except for the above.

### Film Production Examples

### Reference Example 1

The polyimide resin A obtained in the production example and a commercially available polymethyl methacrylate resin (“PARAPET HM1000” manufactured by KURARAY CO., LTD., glass transition temperature: 120° C., acid value: 0.0 mmol/g, hereinafter referred to as “acrylic resin 1”) were dissolved in methylene chloride (DCM) at a weight ratio as shown in Table 1, thereby preparing a solution having a resin content of 11 wt %. This solution was applied onto an alkali-free glass plate, and dried by heating at 60° C. for 15 minutes, 90° C. for 15 minutes, 120° C. for 15 minutes, 150° C. for 15 minutes, 180° C. for 15 minutes, and 200° C. for 15 minutes in an air atmosphere to produce films having a thickness shown in Table 1.

### Reference Examples 2 to 9

Films were produced in the same manner as in Reference Example 1 except that the type of the polyimide resin, the type of the acrylic resin, and the mixing ratio of the polyimide and the acryl-based resin were changed as shown in Table 1. In Reference Examples 4, 7, 8, and 9, since the polyimide resin and the acryl-based resin were incompatible in the methylene chloride solution and the solution became cloudy, a film was produced using DMF as a solvent instead of methylene chloride.

Details of acrylic resins 2 and 3 used in Reference Examples 3, 5, and 8 are as follows.
Acrylic resin 2: Copolymer of methyl methacrylate/methyl acrylate (monomer ratio: 87/13) (“PARAPET G-1000” manufactured by KURARAY CO., LTD.), glass transition temperature: 109° C., acid value: 0.0 mmol/g)
Acrylic resin 3: Acryl-based resin having a glutarimide ring and prepared as described in “acryl-based resin Production Example” in Japanese Patent Laid-open Publication No. 2018-70710 (glutarimide content: 4 wt %, glass transition temperature: 125° C., acid value: 0.4 mmol/g)

### Comparative Example 1

A methylene chloride solution of the polyimide resin C was prepared, and a film having a thickness of about 50 μm was produced under the same conditions as Reference Example 1.

### Comparative Example 2

A film having a thickness of about 50 μm was produced under the same conditions as Reference Example 1 except that a methylene chloride solution of the acrylic resin 1 was prepared, and the conditions during drying were changed to 60° C. for 30 minutes, 80° C. for 30 minutes, 100° C. for 30 minutes and 110° C. for 30 minutes.

### Production Example of Stretched Film

### Example 1

A film containing the polyimide resin A and the acryl-based resin 1 was produced in the same manner as in Reference Example 1, and cut into a rectangle having a long side in the casting direction (MD) in film formation. The short sides (both ends in the longitudinal direction) of the cut rectangle film were chucked, and the distance between chucks was changed in an oven at the temperature shown in Table 1 to perform free-end uniaxial stretching at the stretching ratio shown in Table 1.

### Example 7

A film containing the polyimide resin C and the acryl-based resin 2 was produced in the same manner as in Reference Example 5, and the film was subjected to free-end uniaxial stretching under the conditions shown in Table 1.

### Comparative Example 3

A film of the acryl-based resin 1 was produced in the same manner as in Comparative Example 2, and the film was subjected to free-end uniaxial stretching under the conditions shown in Table 1.

### Example 2

Free-end uniaxial stretching was performed in the same manner as in Example 1 under the conditions shown in Table 1 so that the length of the film in the machine direction (MD) was 1.43 times (stretching ratio: 43%). Thereafter, in a state in which both ends of the film in the MID were chucked and fixed, both ends of the film in the short side direction (TD) were held with clips, and fixed-end uniaxial stretching was performed such that the length of the film in the transverse direction (TD) was 1.45 times that before the free-end uniaxial stretching (stretching ratio: 45%) while changing the distance between the clips, to obtain a biaxially stretched film having an MD stretching ratio of 43% and a TD stretching ratio of 45%.

### Examples 3 to 6 and 8 to 12

The type of the film and stretching conditions were changed as shown in Table 1, and sequential biaxial stretching (free-end uniaxial stretching and fixed-end uniaxial stretching) was performed in the same manner as in Example 2 to obtain biaxially stretched films.

### [Evaluations]

### <Glass Transition Temperature>

The films of Reference Examples 1 to 9 and Comparative Example 1 were subjected to differential scanning calorimetry (DSC) using a differential scanning calorimeter (“DSC7000X” manufactured by Hitachi High-Tech Corporation) under conditions of a temperature raising rate of 10° C./min and a temperature range of 50° C. to 270° C. in a nitrogen atmosphere, and the inflection point of the DSC curve was defined as the glass transition temperature. In Reference Examples 1 to 9, no inflection point was confirmed around the glass transition temperature of the acrylic resin. It was confirmed that the polyimide resin and the acryl-based resin were completely compatible in the resin composition constituting the films of Reference Examples 1 to 9 (and Examples 1 to 12).

### <Haze and Total Light Transmittance>

The film was cut to a 3 cm square, and the haze and the total light transmittance (TT) were measured in accordance with JIS K 7136 and JIS K 7361-1 using a haze meter “HZ—V3” manufactured by Suga Test Instruments Co., Ltd.

### <Yellowness Index>

The film was cut to a 3 cm square, and the yellowness index (YI) was measured in accordance with JIS K 7373 using a spectrophotometer “SC—P” manufactured by Suga Test Instruments Co., Ltd.

### <Determination of First Direction>

Retardation was measured at a wavelength of 589 nm by a parallel Nicole rotation method, using a retardation measuring device “KOBRA” manufactured by Oji Scientific Instruments. The direction of the orientation axis (slow axis direction), that is, a direction in which the in-plane refractive index was maximum was defined as the first direction. A direction orthogonal to the first direction in the film plane (fast axis direction) was defined as the second direction.

### <Refractive Index>

The film was cut into a 3 cm square, and the refractive index n₁ in the first direction and the refractive index n₂ in the second direction of the film were measured by a prism coupler (“2010/M” manufactured by Metricon Corporation). Further, the refractive indexes in the thickness direction in a cross section perpendicular to the first direction and a cross section perpendicular to the second direction were measured, and the average value of the measured values was taken as the thickness direction refractive index n₃.

The in-plane average refractive index n_{H}=(n₁+n₂)/2, the index R (%) of the in-plane refractive index anisotropy: 100×(n₁-n₂)/n₂, and the out-of-plane birefringence n_{H}-n₃ were calculated from n₁, n₂ and n₃.

### <Tensile Modulus>

The film was cut into a strip shape having a width of 10 mm with the first direction as the long side, and this was allowed to stand at 23° C./55% RH for 1 day to adjust the humidity thereof. Then, a tensile test was performed on the film with the first direction as the tensile direction under the following conditions using “AUTOGRAPH AGS-X” manufactured by Shimadzu Corporation to measure the tensile modulus in the first direction. For the stretched films of Examples 1 to 12, a sample cut into a strip shape with the second direction as the long side was used, a tensile test was performed on each film with the second direction as a tensile direction to measure the tensile modulus in the second direction.
Distance between chucks: 100 mm
Tensile speed: 20.0 mm/min
Measurement temperature: 23° C.

### <Pencil Hardness>

According to JIS K5600 May 4 “Pencil Scratch Test,” the pencil hardness of the film was measured with the first direction as the scratching direction (pencil moving direction). For the stretched films of Examples 1 and 3 to 12 and Comparative Example 3, the pencil hardness when the second direction was the scratching direction was also measured.

### <Dynamic Bending Test>

The film was cut into a strip shape of 20 mm×150 mm with the first direction as the long side. The short sides of this sample were attached to a U-shape folding test jig (“DMX-FS” manufactured by Yuasa System Co., Ltd.). Then, under an environment of a temperature of 23° C. and a relative humidity of 55%, a repetition bending test was performed under the conditions of a bending radius of 1.0 mm, a bending angle of 180°, and a bending speed of 1 time/second with the second direction of the film as the bending axis by a desktop endurance test machine (“DMLHB” manufactured by Yuasa System Co., Ltd.) to determine the endurable number of cycles. Specifically, the presence or absence of cracks or breakage of the film was checked every 1,000 times (checked every 50,000 times over 100,000 times) of bending, and the maximum number of times of bending at which cracks or breakage did not occur was defined as the endurable number of cycles.

For the stretched films of Examples 1 to 12, a sample cut into a strip shape with the second direction as the long side was used, and the endurable number of cycles was also measured for the case where the first direction was the bending axis. The endurable number of cycles when the test was performed by using a sample with the first direction as the long side and setting the second direction as the bending axis was defined as the endurable number of cycles in the first direction. The endurable number of cycles when the test was performed using a sample with the second direction as the long side and setting the first direction as the bending axis was defined as the endurable number of cycles in the second direction.

### [Evaluation Results]

For Reference Examples 1 to 9, Examples 1 to 12, and Comparative Examples 1 and 2, composition of the resin (composition of polyimide, type of acryl-based resin, and mixing ratio), glass transition temperature, film preparation conditions (type of solvent and stretching conditions), and thickness, haze, total light transmittance (TT), and yellowness index of the film are shown in Table 1, and the evaluation results of tensile modulus, pencil hardness, endurable number of cycles in the dynamic bending test, and refractive index are shown in Table 2. Those not evaluated for tensile modulus, pencil hardness, the dynamic bending test and refractive index were described as “ND” in the tables.

In Table 1, the compounds are represented by the following abbreviations.

### <Tetracarboxylic Dianhydride>

6FDA: 4,4′-(hexafluoroisopropylidene)diphthalic anhydride
CBDA: 1,2,3,4-Cyclobutanetetracarboxylic dianhydride
TAHMBP: Bis(1,3-dioxo-1,3-dihydroisobenzofuran-5-carboxylic acid)-2,2′,3,3′,5,5′-hexamethylbiphenyl-4,4′-diyl
BPDA: 3,3′,4,4′-Biphenyltetracarboxylic dianhydride
BPADA: 4,4′-(4,4′-Isopropylidenediphenoxy)diphthalic anhydride
PMDA: Pyromellitic dianhydride

### <Dicarboxylic Acid Dichloride>

TPC: Terephthalic acid dichloride
IPC: Isophthalic acid dichloride

### <Diamine>

TFMB: 2,2′-Bis(trifluoromethyl) benzidine
DDS: 3,3′-Diaminodiphenylsulfone

| | Resin composition | | | | | | | | | | | | | | | | | | | | | |
|---|---|---|---|---|---|---|---|---|---|---|---|---|---|---|---|---|---|---|---|---|---|---|
| | | Polyimide composition (mol %) | | | | | | | | | | | | | | Stretching | | | | | | |
| | | | | | | | | Dicarb- | | | | Type | PI/ | | | Tem- | Magni- | | | | | |
| | | | | | | | | oxylic | | | | of | acryl | | | per- | fication | | Thick- | | | |
| | | Acid dianhydride | | | | | | acid | | Diamine | | acrylic | (weight | Tg | Sol- | ature | (%) | | ness | Haze | TT | |
| | | 6FDA | CBDA | TAHMBP | BPDA | BPADA | PMDA | TPC | IPC | TFMB | DDS | resin | ratio) | (° C.) | vent | (° C.) | MD | TD | (μm) | (%) | (%) | YI |
| Reference | A | 70 | 30 | — | — | — | — | — | — | 100 | — | 1 | 50/50 | 178 | DCM | — | | | 58 | 0.3 | 91.7 | 0.5 |
| Example 1 | | | | | | | | | | | | | | | | | | | | | | |
| Example 1 | | | | | | | | | | | | | | | | 210 | 70 | — | 41 | 0.3 | 91.5 | 0.6 |
| Example 2 | | | | | | | | | | | | | | | | 195 | 43 | 45 | 48 | 0.7 | 91 | 0.5 |
| Example 3 | | | | | | | | | | | | | | | | 195 | 61 | 59 | 33 | 0.2 | 91.1 | 0.6 |
| Reference | | | | | | | | | | | | 1 | 30/70 | 150 | DCM | — | | | 36 | 0.2 | 92.1 | 0.4 |
| Example 2 | | | | | | | | | | | | | | | | | | | | | | |
| Example 4 | | | | | | | | | | | | | | | | 150 | 30 | 30 | 42 | 0.3 | 91.9 | 0.3 |
| Reference | | | | | | | | | | | | 3 | 50/50 | 177 | DCM | — | | | 50 | 0.5 | 91.6 | 0.7 |
| Example 3 | | | | | | | | | | | | | | | | | | | | | | |
| Example 5 | | | | | | | | | | | | | | | | 210 | 40 | 30 | 51 | 0.3 | 91.5 | 0.6 |
| Reference | B | 100 | — | — | — | — | — | — | — | 100 | — | 1 | 50/50 | 175 | DCM | — | | | 50 | 0.5 | 91.6 | 0.9 |
| Example 4 | | | | | | | | | | | | | | | | | | | | | | |
| Example 6 | | | | | | | | | | | | | | | | 195 | 40 | 40 | 51 | 0.5 | 91.6 | 0.9 |
| Reference | C | 40 | — | — | — | 20 | 40 | — | — | 80 | 20 | 2 | 50/50 | 168 | DCM | — | | | 53 | 0.3 | 91.1 | 2.3 |
| Example 5 | | | | | | | | | | | | | | | | | | | | | | |
| Example 7 | | | | | | | | | | | | | | | | 195 | 60 | — | 50 | 0.8 | 91.1 | 2 |
| Example 8 | | | | | | | | | | | | | | | | 195 | 30 | 30 | 49 | 0.9 | 91 | 2.2 |
| Comparative | | | | | | | | | | | | — | 100/0 | ND | DCM | — | | | 51 | 0.3 | 39.5 | 7.5 |
| Example 1 | | | | | | | | | | | | | | | | | | | | | | |
| Reference | D | 60 | — | — | 30 | — | — | 10 | — | 100 | — | 1 | 50/50 | 179 | DCM | — | | | 48 | 0.2 | 91.1 | 0.8 |
| Example 6 | | | | | | | | | | | | | | | | | | | | | | |
| Example 9 | | | | | | | | | | | | | | | | 195 | 50 | 50 | 31 | 0.3 | 91 | 0.8 |
| Reference | E | — | 20 | 50 | — | — | — | 30 | — | 100 | — | 1 | 50/50 | 165 | DMF | — | | | 48 | 0.3 | 91.3 | 0.7 |
| Example 7 | | | | | | | | | | | | | | | | | | | | | | |
| Example 10 | | | | | | | | | | | | | | | | 195 | 40 | 30 | 47 | 0.3 | 91 | 0.9 |
| Reference | F | 70 | — | — | — | — | — | — | 30 | 100 | — | 1 | 50/50 | 161 | DMF | — | | | 50 | 0.6 | 91.6 | 0.8 |
| Example 8 | | | | | | | | | | | | | | | | | | | | | | |
| Example 11 | | | | | | | | | | | | | | | | 170 | 50 | 50 | 47 | 0.5 | 91.5 | 0.9 |
| Reference | G | 15 | 15 | — | — | — | — | 70 | — | 100 | — | 3 | 50/50 | 162 | DMF | — | | | 50 | 1.5 | 90.6 | 4 |
| Example 9 | | | | | | | | | | | | | | | | | | | | | | |
| Example 12 | | | | | | | | | | | | | | | | 210 | 10 | 10 | 52 | 1.5 | 90.7 | 3.2 |
| Comparative | — | | | | | | | | | | | 1 | 0/100 | 120 | DCM | — | | | 51 | 0.3 | 92.5 | 0.2 |
| Example 2 | | | | | | | | | | | | | | | | | | | | | | |
| Comparative | | | | | | | | | | | | | | | | 145 | 70 | — | 48 | 0.3 | 92.6 | 0.2 |
| Example 3 | | | | | | | | | | | | | | | | | | | | | | |

TABLE 2

| | | | | Stretching | | | | | | | | | | | | | | |
|---|---|---|---|---|---|---|---|---|---|---|---|---|---|---|---|---|---|---|
| | Resin composition | | | conditions | | | | | | | | | | | | | | |
| | Type | Type | PI/ | Tem- | Magni- | | Tensile modulis | | | | Dynamic bending | | | | | | | |
| | of | of | acryl | per- | fication | | (GPa) | | Pencil hardness | | (1,000 times) | | Refractive index | | | | | |
| | poly- | acrylic | (weight | ature | (%) | | First | Second | First | Second | First | Second | | | | R | | |
| | imide | resin | ratio) | (° C.) | MD | TD | direction | direction | direction | direction | direction | direction | n₁ | n₂ | n_{H} | (%) | n₃ | n_{H}-n₃ |
| Reference | A | 1 | 50/50 | — | | | 3.9 | ND | 2H | ND | 13 | ND | 1.5287 | 1.5287 | 1.5287 | 0 | 1.5149 | 0.0139 |
| Example 1 | | | | | | | | | | | | | | | | | | |
| Example 1 | | | | 210 | 70 | — | 6.3 | 3.4 | H | 2H | 550 | 400 | 1.56 | 1.5111 | 1.5355 | 3.24 | 1.5029 | 0.0326 |
| Example 2 | | | | 195 | 43 | 45 | 4.6 | 4.3 | 3H | ND | 450 | 400 | 1.5338 | 1.5283 | 1.5311 | 0.36 | 1.5035 | 0.0275 |
| Example 3 | | | | 195 | 61 | 59 | 5.2 | 4.3 | H | H | 1,250 | 1,250 | 1.5374 | 1.5295 | 1.5335 | 0.52 | 1.4992 | 0.0343 |
| Reference | | 1 | 30/70 | — | | | 3.4 | ND | HB | ND | <1 | ND | 1.5118 | 1.5114 | 1.5116 | 0.03 | 1.5063 | 0.0053 |
| Example 2 | | | | | | | | | | | | | | | | | | |
| Example 4 | | | | 150 | 30 | 30 | 3.6 | 3.5 | H | H | 200 | 200 | 1.5153 | 1.5146 | 1.515 | 0.05 | 1.5001 | 0.0148 |
| Reference | | 3 | 50/50 | — | | | 3.7 | ND | ND | | <1 | ND | ND | | | | | |
| Example 3 | | | | | | | | | | | | | | | | | | |
| Example 5 | | | | 210 | 40 | 30 | 4.3 | 4.2 | 2H | 2H | 250 | 200 | h8i | 1.5309 | 1.5309 | 0 | 1.5067 | 0.0243 |
| Reference | B | 1 | 50/50 | — | | | 3.4 | ND | ND | | <1 | ND | 1.5237 | 1.5236 | 1.5236 | 0.01 | 1.5183 | 0.0054 |
| Example 4 | | | | | | | | | | | | | | | | | | |
| Example 6 | | | | 195 | 40 | 40 | 3.9 | 3.8 | 3H | H | 100 | 100 | 1.5301 | 1.5275 | 1.3288 | 0.17 | 1.5089 | 0.0199 |
| Reference | C | 2 | 50/50 | — | | | 3.8 | ND | ND | | #REF! | ND | 1.5449 | 1.5446 | 1.5447 | 0.02 | 1.5335 | 0.0112 |
| Example 5 | | | | | | | | | | | | | | | | | | |
| Example 7 | | | | 195 | 60 | — | 4.8 | 3.7 | 2H | 2H | 100 | 10 | 1.5616 | 1.5384 | 1.55 | 1.51 | 1.5231 | 0.0269 |
| Example 8 | | | | 195 | 30 | 30 | 4 | 4.1 | H | F | 150 | 150 | 1.5541 | 1.5466 | 1.5504 | 0.48 | 1.5223 | 0.0281 |
| Comparative | | — | | — | | | 4 | ND | 3H | ND | 200 | ND | ND | | | | | |
| Example 1 | | | | | | | | | | | | | | | | | | |
| Reference | D | 1 | 50/50 | — | | | 4 | ND | H | ND | 25 | ND | 1.5405 | 1.5396 | 1.5401 | 0.06 | 1.5266 | 0.0134 |
| Example 6 | | | | | | | | | | | | | | | | | | |
| Example 9 | | | | 195 | 50 | 50 | 4.8 | 4.2 | F | F | 400 | 300 | 1.5508 | 1.5508 | 1.5508 | 0 | 1.5047 | 0.0461 |
| Reference | E | 1 | 50/50 | — | | | 4.4 | ND | ND | | | ND | ND | | | | | |
| Example 7 | | | | | | | | | | | | | | | | | | |
| Example 10 | | | | 195 | 40 | 30 | 5.6 | 5.2 | 4H | 4H | 200 | 200 | 1.5584 | 1.5535 | 1.556 | 0.31 | 1.5106 | 0.0453 |
| Reference | F | 1 | 50/50 | — | | | 3.2 | ND | ND | | <1 | ND | 1.53 | 1.5299 | 1.53 | 0.01 | 1.5216 | 0.0084 |
| Example 8 | | | | | | | | | | | | | | | | | | |
| Example 11 | | | | 170 | 50 | 50 | 3.5 | 3.5 | 2H | HB | 100 | 100 | 1.5374 | 1.537 | 1.5372 | 0.03 | 1.5184 | 0.0188 |
| Reference | G | 3 | 50/50 | — | | | 4.9 | ND | ND | | <1 | ND | ND | | | | | |
| Example 9 | | | | | | | | | | | | | | | | | | |
| Example 12 | | | | 210 | 10 | 10 | 5.3 | 5.1 | 4H | 4H | 100 | 100 | 1.5543 | 1.5495 | 1.5519 | 0.31 | 1.5157 | 0.0362 |
| Comparative | — | 1 | 0/100 | — | | | 2.6 | ND | HB | ND | <1 | ND | 1.4932 | 1.4931 | 1.4931 | 0.01 | 1.4929 | 0.0003 |
| Example 2 | | | | | | | | | | | | | | | | | | |
| Comparative | | | | 145 | 70 | — | 2.6 | ND | HB | 3B | <1 | ND | 1.4926 | 1.4924 | 1.4925 | 0.01 | 1.4923 | 0.0002 |
| Example 3 | | | | | | | | | | | | | | | | | | |

Both the unstretched films of Reference Examples 1 to 9 containing a polyimide resin and an acryl-based resin and the stretched films of Examples 1 to 12 obtained by stretching these films had a haze of 2% or less and a total light transmittance of 90% or more, and had high transparency similar to the acrylic films of Comparative Examples 1 and 2.

The polyimide film of Comparative Example 1 had a yellowness index of 7.5, whereas the films of Reference Example 5 and Examples 7 and 8 had a yellowness index smaller than that of Comparative Example 1. It was found that by mixing the polyimide with the acryl-based resin, a film with less coloration can be obtained as compared with the case of using the polyimide alone.

In the unstretched film of Reference Example 1, the film had no in-plane refractive index anisotropy, and the tensile modulus was 3.9 GPa and the endurable number of cycles in the dynamic bending test was 13,000. In Examples 1 to 3 in which the film of Reference Example 1 was stretched, the in-plane average refractive index n_{H} was larger and the thickness direction refractive index n₃ was smaller than those in Reference Example 1, and accordingly, the out-of-plane birefringence n_{H}-n₃ was larger. In Examples 1 to 3, the tensile modulus in the first direction was larger than that in Reference Example 1. In Examples 2 and 3, which are biaxially stretched films, the refractive index n₂ in the second direction was larger, and the tensile modulus in the second direction was also larger than those in Reference Example 1. In contrast, in the uniaxially stretched film of Example 1, the refractive index n₂ in the second direction was smaller, and the tensile modulus in the second direction was smaller than those in Reference Example 1. From these results, it is found that the refractive index in the stretching direction increases with stretching, the tensile modulus in the stretching direction increases with the increase in the refractive index, and a film having a large tensile modulus in all directions in the film plane is thus obtained by biaxial stretching.

Further, in the stretched films of Examples 1 to 3 having a larger out-of-plane birefringence n_{H}-n₃ than that of Reference Example 1, the endurable number of cycles in the first direction and the endurable number of cycles in the second direction were both 400,000 times or more, and it is found that the bending resistance is significantly improved as compared with the unstretched film of Reference Example 1.

Comparison between Reference Example 2 and Example 4 in which the ratio of the polyimide resin to the acryl-based resin was changed also shows that stretching increases the out-of-plane birefringence, the tensile modulus in the stretching direction, and also increases the endurable number of cycles in the first direction and the second direction. Comparison between Reference Example 3 and Example 5 in which the type of the acryl-based resin was changed showed a similar tendency. Comparison between Reference Example 4 and Example 6 in which the type of the polyimide resin was changed, and comparison between Reference Example 5 and Example 8 showed a similar tendency.

The biaxially stretched films of Examples 9 to 12 containing a polyamideimide and an acrylic resin also had large out-of-plane birefringence, and improved tensile modulus and bending resistance in the first direction and the second direction as compared with the unstretched films of Reference Examples 6 to 9.

In Reference Examples 4, 7, 8, and 9 and Examples 6, 10,11, and 12, since the polyimide (polyamideimide) and the acrylic resin did not exhibit compatibility in DCM, films were produced using DMF as a solvent. It is found that in these examples, stretching increases the in-plane refractive index, and significantly improves the mechanical strength.

In Example 7 in which the film of Reference Example 5 was uniaxially stretched, the refractive index n₁ in the first direction (stretching direction) increased, and the tensile modulus and the bending resistance in the first direction were improved with the increase in the refractive index, while the refractive index n₂ in the second direction decreased, so that the tensile modulus decreased. Comparison between Example 7 and Example 8 shows that a film having excellent mechanical strength in all directions in the film plane can be obtained by biaxially stretching the film.

In the film of Comparative Example 2 obtained by stretching the film made of the acrylic resin 1 alone, no significant change was observed between the in-plane refractive index and the out-of-plane refractive index, and no clear difference was observed in the tensile modulus as compared with the unstretched film of Comparative Example 1. The films of Comparative Examples 1 and 2 were inferior in mechanical strength to the films of Examples.

The above results show that the film made of the compatible system of the polyimide and the acryl-based resin has excellent transparency comparable to that of a film made of an acryl-based resin alone, and the refractive index anisotropy of such a film is increased by stretching, and accordingly, the tensile modulus and the bending resistance are significantly improved, so that a transparent film having excellent mechanical strength that cannot be achieved by an acryl-based resin film is obtained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A film comprising:
a polyimide; and
an acryl-based resin,
wherein:
an in-plane average refractive index n_{H} and a thickness direction refractive index n₃ of the film satisfy n_{H}-n_{3≥0.0140}, where the in-plane average refractive index n_{H} is an average value of a refractive index n₁ in a first direction in which refractive index in a film plane is maximum and a refractive index n₂ in a second direction orthogonal to the first direction in the film plane, and
the film has a total light transmittance of 85% or more, a haze of 10% or less, and a yellowness index of 5 or less.

2. The film according to claim 1, wherein the refractive index n₁ in the first direction and the refractive index n₂ in the second direction satisfy 100×(n₁−n₂)/n₂<1.0.

3. The film according to claim 1, wherein each of a tensile modulus in the first direction and a tensile modulus in the second direction is 3.5 GPa or more.

4. The film according to claim 1, wherein the film is a stretched film that is stretched in at least one direction.

5. The film according to claim 4, wherein the film is a biaxially stretched film.

6. The film according to claim 1, having a glass transition temperature of 110° C. or higher and lower than 250° C.

7. The film according to claim 1, wherein the polyimide contains a diamine-derived structure represented by general formula (IIa) and a tetracarboxylic-dianhydride-derived structure represented by general formula (IIIa), 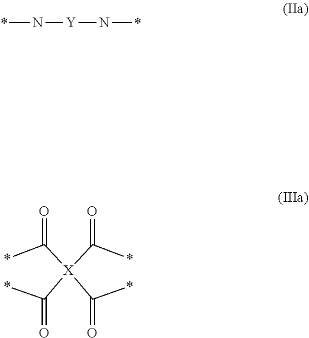
Y is a diamine residue, which is a divalent organic group, and X is a tetracarboxylic dianhydride residue, which is a tetravalent organic group,
wherein at least one of the diamine-derived structure and the tetracarboxylic-dianhydride-derived structure has a fluoroalkyl group.

8. The film according to claim 7, wherein the polyimide contains a structure derived from a diamine having a fluoroalkyl group as the diamine-derived structure.

9. The film according to claim 8, wherein the diamine having a fluoroalkyl group is a fluoroalkyl-substituted benzidine.

10. The film according to claim 8, wherein the diamine having a fluoroalkyl group is 2,2′-bis(trifluoromethyl) benzidine.

11. The film according to claim 7, wherein the polyimide contains a structure derived from at least one tetracarboxylic dianhydride selected from the group consisting of a tetracarboxylic dianhydride having a fluoroalkyl group and an alicyclic tetracarboxylic dianhydride as the tetracarboxylic-dianhydride-derived structure.

12. The film according to claim 7, wherein the polyimide further contains a dicarboxylic-acid-derived structure represented by general formula (Va), 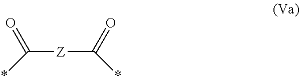
Z is a dicarboxylic-acid residue, which is a divalent organic group,

13. The film according to claim 1, wherein a total amount of methyl methacrylate and modified structures of methyl methacrylate is 60 wt % or more based on an amount of all monomer components in the acryl-based resin.

14. The film according to claim 1, wherein the acryl-based resin has a glass transition temperature of 80° C. or higher.

15. The film according to claim 1, containing the polyimide and the acryl-based resin at a weight ratio in a range of from 98:2 to 2:98.

16. A production method of the film according to claim 1, comprising stretching an unstretched film in at least one direction, wherein the unstretched film contains the polyimide and the acryl-based resin.

17. The production method of the film according to claim 16, wherein the stretching is biaxially stretching the unstretched film.

18. The production method of the film according to claim 16, wherein a temperature during the stretching is lower than 250° C.

19. The production method of the film according to claim 16, wherein the unstretched film is produced by applying a resin solution in which the polyimide and the acryl-based resin are dissolved in an organic solvent onto a support, and thereafter removing the organic solvent.

20. An image display device, comprising:
an image display panel; and
the film according to claim 1 arranged on a surface on a viewing side of the image display panel.

21. The image display device according to claim 20, wherein the device is bendable.
